(19) United States
(12) Patent Application Publication
(10) Pub. No.: US 2026/0370038 A1
(43) Pub. Date: Nov. 19, 2026

(54) SYSTEMS AND METHODS FOR REALIZING BOTH CONSTANT CURRENT AND CONSTANT VOLTAGE CHARGING BY A SINGLE COMPENSATION TOPOLOGY IN AN INDUCTIVE POWER TRANSFER SYSTEM

(71) Applicant: OmniOn Power Technology GmbH, Baden (CH)

(72) Inventors: Lishen Zhou, Shanghai City (CN); Xiaojian Zhao, Shanghai City (CN); Tom Sun, Shanghai City (CN); Ming Fu, Shanghai City (CN)

(21) Appl. No.: 19/154,514

(22) PCT Filed: May 6, 2024
(86) PCT No.: PCT/CN2024/091229

§ 371 Date: Aug. 7, 2025

(51) Int. Cl. H02J 50/12; H02J 7/90; H02J 50/80

(52) U.S. Cl. CPC H02J 50/12; H02J 7/933; H02J 50/80; H02J 2207/20

(57) ABSTRACT

A wireless inductive power transfer (IPT) system for wirelessly charging a battery-powered device. The wireless IPT system includes a transmitter configured to transmit a primary alternating current (AC) power, a receiver inductively coupled with the transmitter that receives the primary AC power and outputs a secondary AC power that is rectified into a direct current (DC) output power for transmission, and a controller for charging of a battery associated with the wireless IPT system, the controller controlling a current and/or voltage of the wireless IPT system to serve as an input control variable for entering into and/or switching between a first charging mode and a second charging mode.

### CROSS-REFERENCE TO RELATED APPLICATION

This application is a National Stage Entry of International application No. PCT/CN2024/091229, filed May 6, 2024, which is herein incorporated by reference in its entirety.

### BACKGROUND

### Field of Invention

The field of the disclosure relates generally to power transfer, and more particularly, to systems and methods for wireless power transfer for charging battery-powered devices.

### Description of Related Art

Wireless inductive power transfer (IPT) systems are based on magnetic coupling between two coils of a transformer. Such coils are generally located in mating pads, one pad in the device, and a mating pad in a charger associated with the device (for charging of the device). The first coil of the transformer is mounted on the charger side. The second coil is installed in the device. Typically, single-phase or three-phase AC power supply is first rectified to DC, and then the rectified DC is inverted to high frequency AC in the charger. The high frequency power is transferred to a battery of the device through magnetically coupled primary and secondary coils. The high-frequency AC power received through the device-side coil is converted to DC to charge the battery of the device, using a magnetic field to transfer electrical energy from a transmitter to a receiver side.

IPT systems are used in a variety of applications, in particular as part of power systems for power devices such as robots and other battery-operated devices including but not limited to electric vehicles. For example, there are industrial-grade robots capable of lifting and moving goods in a warehouse, and/or navigating within a factory to perform roving inspections or other tasks (e.g., cleaning). Certain categories of these robots may be referred to automated guide vehicles (AGVs). As these robots move along a prescribed guidance path, there may be charging base stations along the way for charging their onboard battery. Similarly, in the consumer robot context, devices such as robot vacuums and robot lawnmowers may self-navigate to a charging base station to charge their onboard battery. These charging base stations may utilize IPT technology, where the robot has certain IPT circuitry and components (e.g., coils, etc.) onboard that interfaces with IPT circuitry and components (e.g., coils, etc.) present in the base station, whereby when the respective IPT circuitry is in a certain proximity with one another, wireless charging can occur via the adjacent coils. In the context of an electric vehicle that operates on an electric motor, such a vehicle may be a battery electric vehicle (BEV), a plug-in hybrid electric vehicle (PHEV), or a hybrid electric vehicle (HEV). These vehicles may include battery charging configurations that utilize IPT. For example, a garage floor could be outfitted with an IPT system capable of charging the vehicle battery when the vehicle is parked over the charging portion of the garage floor.

Generally, there are two stages for battery charging in IPT applications. One is constant current (CC) charging, and the other is constant voltage (CV) charging. Most of the energy is delivered from the charger to the battery during CC mode, and as such the period of CC is typically much longer than that of CV. Conventional techniques require complex circuit designs and a plurality of circuit components such as switches to be able to switch between CC and CV modes. Moreover, switching can be inefficient and lead to losses. For example, conventional switching requires hard switching/stoppage of one mode before switching to/starting the other mode. As such, there is a need for IPT circuit topologies that have simpler designs, use fewer components, and either remove the need for switching or switching more efficiently (such as by using software to perform control tasks that amount to switching between CC/CV modes without having to actually switch in the same sense as conventional techniques, thereby resulting in smoother switching).

### SUMMARY

In one aspect, a wireless inductive power transfer (IPT) system for wirelessly charging a battery-powered device associated with the wireless IPT system. The wireless IPT system comprises a transmitter side subsystem comprising a transmitter, the transmitter configured to transmit a primary alternating current (AC) power. The wireless IPT system further comprises a receiver side subsystem comprising a receiver, the receiver inductively coupled with the transmitter and configured to receive the primary AC power and output a secondary AC power. The secondary AC power is rectified into a DC output power for transmission. The wireless IPT system further comprises a controller operatively coupled to the transmitter side subsystem and the receiver side subsystem. The controller is configured to control charging of a battery associated with the wireless IPT system by controlling a current and/or a voltage of the receiver side subsystem to serve as an input control variable for entering into and/or switching between a constant current (CC) mode of the charging and a constant voltage (CV) mode of the charging using the same topology of a circuit of the wireless IPT system.

In another aspect, a method of operating a wireless inductive power transfer (IPT) system for wirelessly charging a battery-powered device associated with the wireless IPT system. The wireless IPT system comprises a transmitter side subsystem comprising a transmitter. The wireless IPT system further comprises a receiver side subsystem comprising a receiver, the receiver inductively coupled with the transmitter. The wireless IPT system further comprises a controller operatively coupled to the transmitter side subsystem and the receiver side subsystem. The method comprises transmitting, via the transmitter, a primary alternating current (AC) power. The method further comprises receiving, via the receiver, the primary AC power, outputting, via the receiver, a secondary AC power. The secondary AC power is rectified into a DC output power for transmission. The method further comprises controlling, via the controller, charging of a battery associated with the wireless IPT system by controlling a current and/or a voltage of the receiver side subsystem to serve as an input control variable for entering into and/or switching between a constant current (CC) mode of the charging and a constant voltage (CV) mode of the charging using the same topology of a circuit of the wireless IPT system.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings.

FIG. 1A is a diagram of an example wireless inductive power transfer (IPT) system as disclosed herein.

FIG. 1B is a schematic diagram of an example embodiment of the system shown in FIG. 1A.

FIG. 1C is a prior art schematic of hybrid series-series (SS) and LC-S compensation topologies.

FIG. 1D is a prior art schematic of hybrid SS and LCC-S compensation topologies.

FIG. 1E is a high-level circuit diagram of an example embodiment of a compensation circuit of the system shown in FIG. 1B.

FIG. 1F is a high-level circuit diagram for an example series-series (SS) circuit topology in a constant current (CC) mode of the embodiment shown in FIG. 1B.

FIG. 1G is a high-level circuit diagram for an example SS circuit topology in CC mode of the embodiment shown in FIG. 1F, regarding a switching frequency of the system.

FIG. 1H is a high-level circuit diagram for an example SS circuit topology in constant voltage (CV) mode of the embodiment shown in FIG. 1B.

FIG. 1I is a high-level circuit diagram for an example SS circuit topology in CV mode of the embodiment shown in FIG. 1H, regarding switching frequency.

FIG. 1J is a high-level circuit diagram of another example embodiment of a compensation circuit of the system shown in FIG. 1B.

FIG. 1K is a block diagram of aspects of an example transmitter as disclosed herein.

FIG. 1L is a graph illustrating aspects of an inverter output as disclosed herein.

FIG. 1M is a graph illustrating aspects of a phase angle shift adjusting V_{AB} as disclosed herein.

FIG. 1N is a flow chart of an example method of operating an IPT system as disclosed herein.

FIG. 2A is an example voltage and current graph plotted against time for CC and CV modes as disclosed herein.

FIG. 2B is a table of parameters for SS, series-parallel (SP), parallel-series (PS), and parallel-parallel (PP) topologies as disclosed herein.

FIG. 2C is a table of parameters for LC-S and LCC-S topologies as disclosed herein.

FIG. 3A is a block diagram of an example CC mode with a DC/DC stage before an inverter in the example embodiment of the system shown in FIG. 1B in a principal diagonal topology.

FIG. 3B is a block diagram of an example CC mode without a DC/DC stage before an inverter in the example embodiment of the system shown in FIG. 1B in a principal diagonal topology.

FIG. 3C is a block diagram of an example CV mode with a DC/DC stage before an inverter in the example embodiment of the system shown in FIG. 1B in a principal diagonal topology.

FIG. 3D is a block diagram of an example CV mode without a DC/DC stage before an inverter in the example embodiment of the system shown in FIG. 1B in a principal diagonal topology.

FIG. 4A is a block diagram of an example CV mode with a DC/DC stage before an inverter in the example embodiment of the system shown in FIG. 1B in a secondary diagonal topology.

FIG. 4B is a block diagram of an example CV mode without a DC/DC stage before an inverter in the example embodiment of the system shown in FIG. 1B in a secondary diagonal topology.

FIG. 4C is a block diagram of an example CC mode with a DC/DC stage before an inverter in the example embodiment of the system shown in FIG. 1B in a secondary diagonal topology.

FIG. 4D is a block diagram of an example CC mode without a DC/DC stage before an inverter in the example embodiment of the system shown in FIG. 1B in a secondary diagonal topology.

FIG. 5A is a schematic for an example feedback loop configuration using Iᵢₙ as a reference of an inner loop in CV mode with a DC/DC stage before an inverter in accordance with embodiments disclosed herein.

FIG. 5B is a schematic for an example feedback loop configuration using lₚ as a reference of an inner loop in CV mode with a DC/DC stage before an inverter in accordance with embodiments disclosed herein.

FIG. 5C is a schematic for an example feedback loop configuration using Iᵢₙ as a reference of an inner loop in CV mode with a phase shift full bridge in accordance with embodiments disclosed herein.

FIG. 5D is a schematic for an example feedback loop configuration using lₚ as a reference of an inner loop in CV mode with a phase shift full bridge in accordance with embodiments disclosed herein.

### DETAILED DESCRIPTION

The disclosure includes systems, apparatuses, methods, and other techniques for realizing hardware and software improvements in circuit technology used for IPT, and more specifically for improving CC and CV charging modes in such IPT circuitry. This disclosure describes how it is possible to realize both CC and CV charging modes using a single compensation topology in a wireless IPT system, thereby providing benefits including but not limited to reducing the amount of and/or need for circuit components such as switches, generally improving the process of switching back and forth between CC and CV modes and improving the safety and efficient charging of batteries. Moreover, using the disclosed techniques, any single topology can achieve both CC and CV, and control can be variable and implemented via software (allowing for smoother switching compared to prior techniques). This advancement has a wide variety of applications in wireless IPT systems and related technology and represents an improvement over conventional techniques. For example, and without limitation, the systems and methods described herein may be applied to consumer and industrial robots, electric vehicles, and other devices that may benefit from wireless charging capabilities. Method aspects will be in part apparent and in part explicitly discussed in the following description.

A wireless IPT system for charging a battery has certain advantages over conventional plug-in charging systems, such as elimination of charger connecters and user convenience. In the example of an AGV, wireless charging stations may be positioned at various locations within a factory, allowing for charging in a variety of locations at the robot roams the factory performing tasks. A wireless IPT system may be used to charge the devices referenced herein and similar devices, in particular high-power devices such as industrial robots or electric vehicles. A loosely coupled transformer configuration is generally preferred for such applications, as the types of coils used in such configurations allow for wireless charging to occur at greater distances as compared, for example, to the wireless charging that used directly coupled transformer technology (where the charger pads have to be in very close proximity to one another).

The inductive power transfer (IPT) technique in battery charging applications has many advantages compared to conventional plug-in systems and conventional wireless power circuit designs and control (e.g., switching) schemes. The four basic IPT circuit topologies with series-series (SS), series-parallel (SP), parallel-series (PS), and parallel-parallel (PP) compensations can achieve constant charging current (e.g., constant current, “CC”) or constant battery charging voltage (e.g., constant voltage, “CV”). The load-independent current output circuit is suited for CC and load-independent voltage output circuit is suited for CV. Some complicated compensation circuits, for example LC, LCC, have characteristics as CC or CV and can be used too. As such, additional IPT circuit topologies include LC-S and LCC-S configurations. If only the input voltage of the resonant tank is regulated, these topologies only have CC or CV characteristic. In order to realize both CC and CV modes, many hybrid topologies have been proposed, where extra switches are added to switch between CC and CV during the charging of the battery. However, this complicates circuit design and tends to introduce losses. Instead, if the input current of the resonant tank is regulated as described herein, these various topologies can achieve both CC and CV easily by themselves, as will be explained in greater detail herein. This improvement in charging circuit design and control represents an improvement in both circuit and computing technology, an advancement over conventional techniques, and achieves a plurality of benefits as disclosed herein.

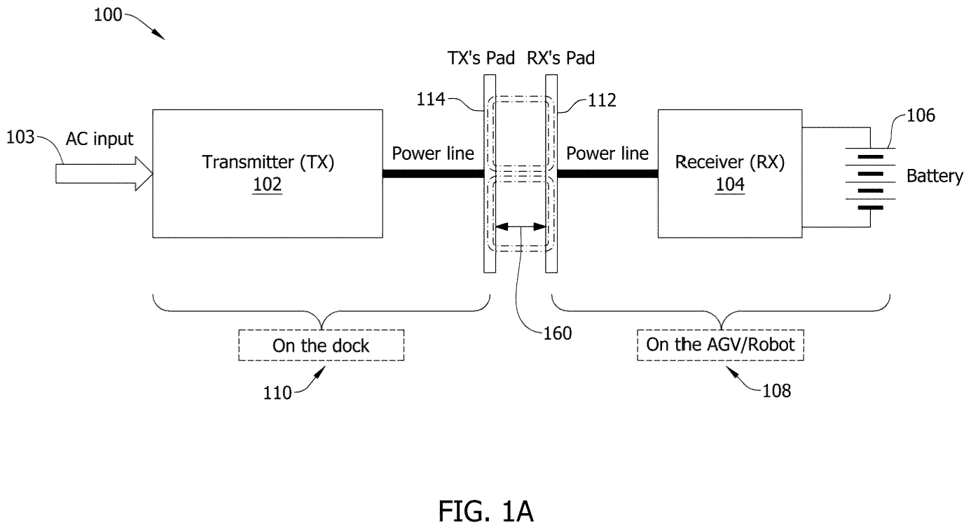

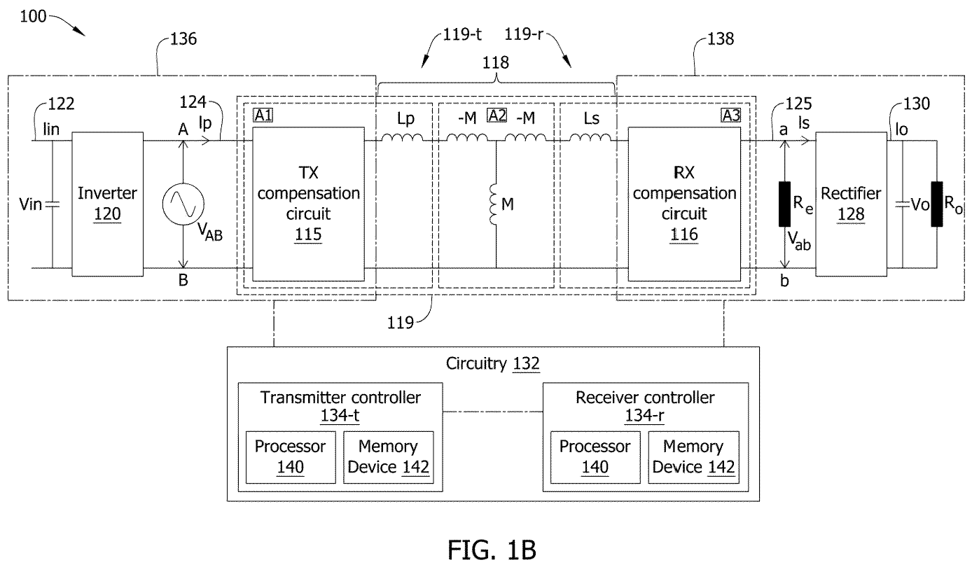

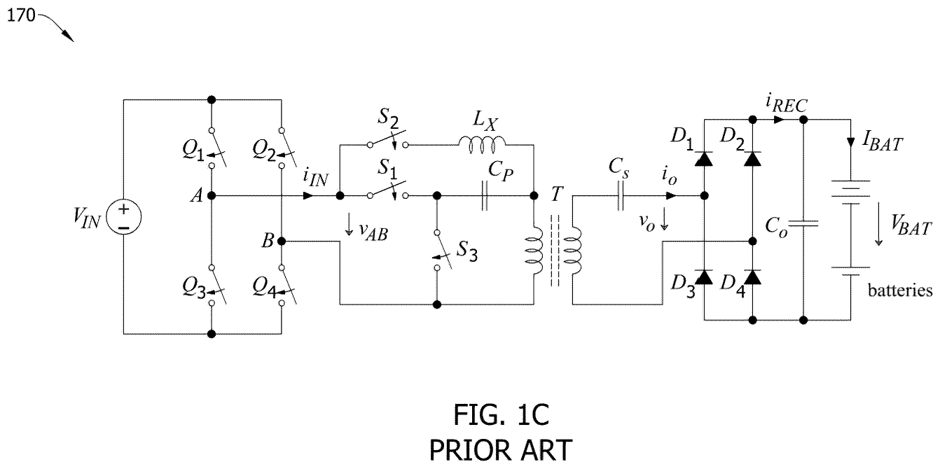

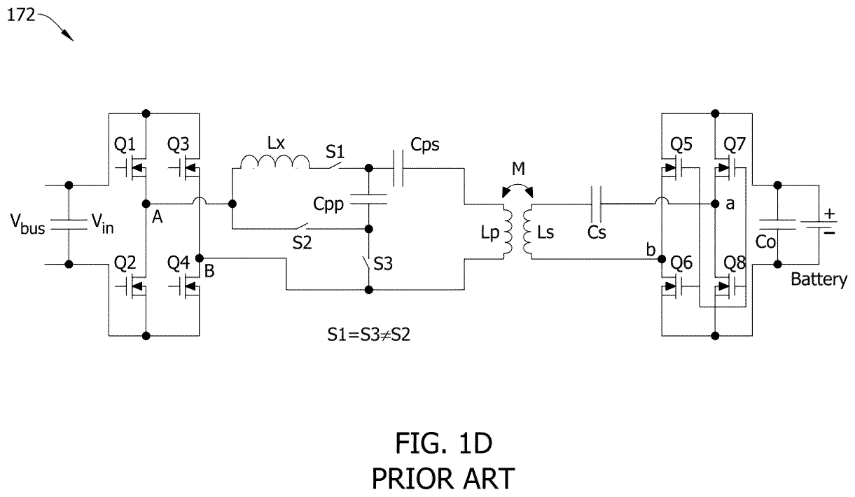

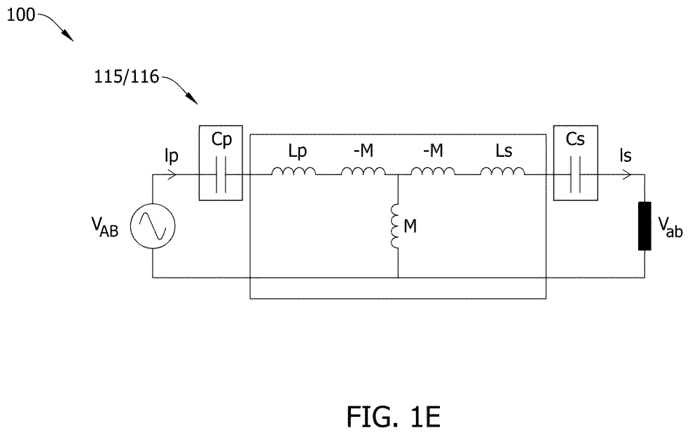

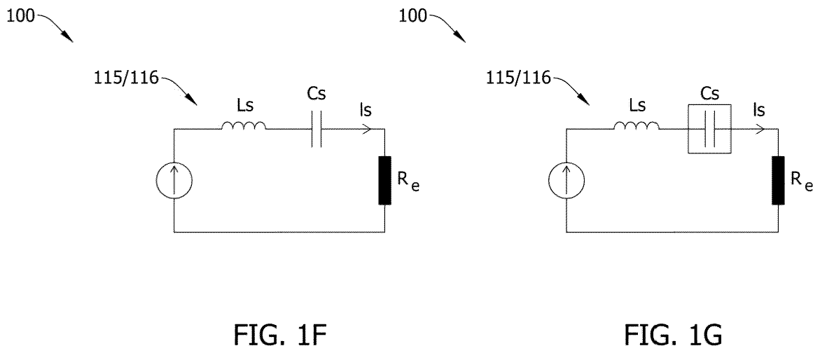

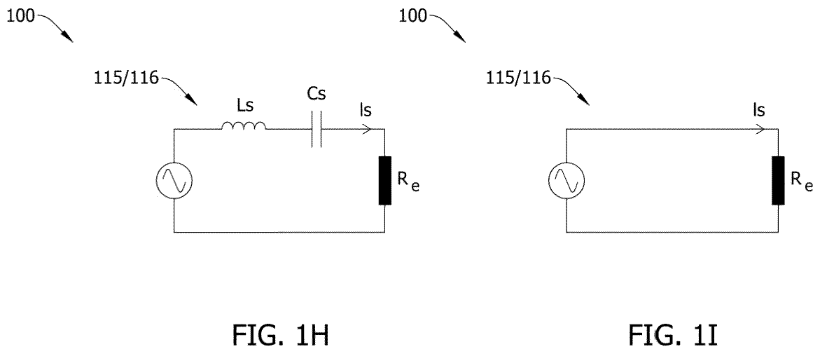

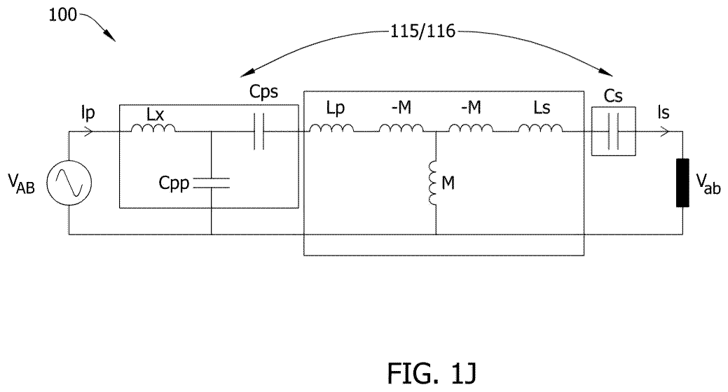

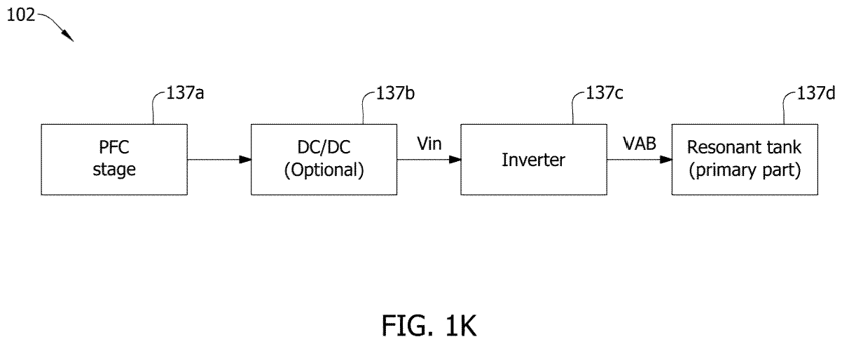

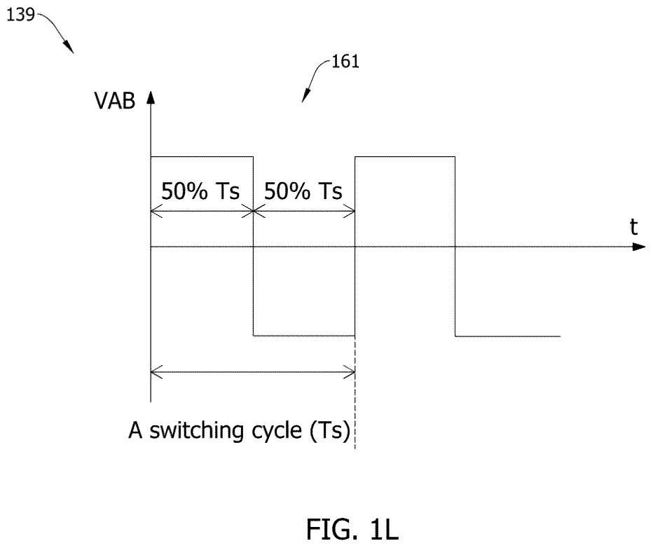

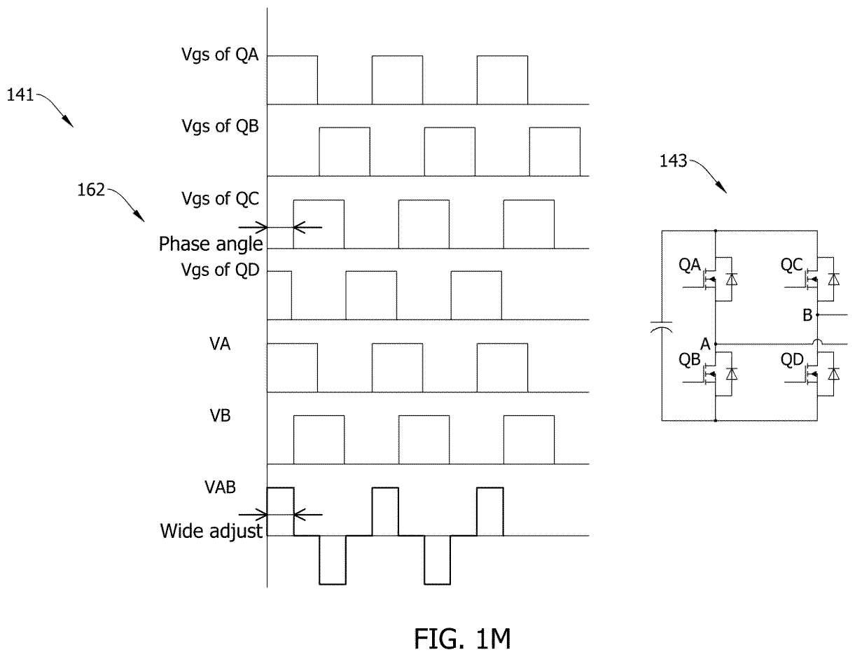

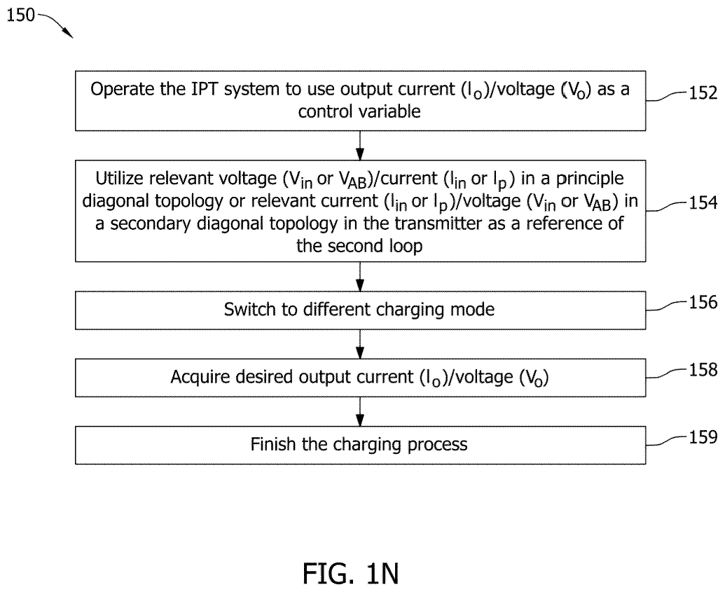

FIGS. 1A, 1B, and 1E-1M show example embodiments of wireless IPT system 100 according to the present disclosure. FIGS. 1C and 1D show conventional IPT circuit designs. FIG. 1N shows an example embodiment of a method 150 for realizing both CC and CV charging modes using a single compensation topology in system 100 according to the present disclosure. FIG. 1A is a diagram of an example wireless inductive power transfer (IPT) system 100. FIG. 1B is a schematic diagram of an example embodiment of the system 100 shown in FIG. 1A. FIG. 1C is a conventional IPT circuit 170. FIG. 1D is a conventional IPT circuit 172. FIG. 1E is a high-level circuit diagram of an example embodiment of a compensation circuit 115/116 of the system 100 shown in FIG. 1B. FIG. 1F is a high-level circuit diagram for an example SS circuit topology in CC mode of the embodiment shown in FIG. 1B. FIG. 1G is a high-level circuit diagram for an example SS circuit topology in CC mode of the embodiment shown in FIG. 1F, regarding switching frequency of the system. FIG. 1H is a high-level circuit diagram for an example SS circuit topology in CV mode of the embodiment shown in FIG. 1B. FIG. 1I is a high-level circuit diagram for an example SS circuit topology in CV mode of the embodiment shown in FIG. 1H, regarding switching frequency of the system. FIG. 1J is a high-level circuit diagram of another example embodiment (LCC-S) of a compensation circuit of the system shown in FIG. 1B. FIG. 1K is a block diagram of aspects of an example transmitter as disclosed herein. FIG. 1L is a graph illustrating switching cycle aspects of an output of the inverter (V_{AB}) with a DC/DC stage as disclosed herein. FIG. 1M is a graph illustrating aspects of phase angle shift adjusting V_{AB} as disclosed herein.

In the example embodiment in FIG. 1B, the system 100 includes a transmitter side subsystem 136 at the transmitter side, which includes a transmitter 102 connected to an AC input 103 (see also FIG. 1A). The transmitter side may be referred to as the primary side. The transmitter side subsystem 136 is configured to receive electrical power from a power source. The system 100 further includes a receiver side subsystem 138 at the receiver side, which includes a receiver 104 (see also FIG. 1A). The receiver side may be referred to as the secondary side. The receiver 104 is inductively coupled with the transmitter 102 via corresponding respective pads (112, 114) of each. The receiver side subsystem 138 is configured to output electrical power to a battery 106 of a battery-powered device 108 to charge the battery 106 (see also FIG. 1A). In between subsystems 136 and 138 are components that function as a transformer 118, which may be a loosely coupled transformer designed for wireless power applications.

In operation, a battery-powered device is placed in proximity to a dock of a charging station to charge. In an example embodiment, a battery-powered device 108 such as an AGV is placed in proximity to a dock of a charging station 110 (e.g., the AGV 108 can navigate or be navigated to the dock). As shown in FIG. 1A, receiver pad 112 of the AGV is placed adjacent to a transmitter pad 114 of the charging station. Receiver pad 112 of the AGV has one or more corresponding coil(s) therein. Transmitter pad 114 of the charging station has one or more corresponding coil(s) therein. The transmitter 102 is loosely, inductively coupled with the receiver 104 and power is transmitted by the transmitter 102 to the receiver 104 via the coils of the pads to charge the battery 106 of the AGV 108.

At least in part because of the loose coupling between the transmitter 102 side and the receiver 104 side, compensation circuits 115, 116 may be included in the primary side (or the transmitter side) and the secondary side (or the receiver side) (see FIG. 1B) to improve power transfer efficiency and/or provide electrical compensation in connection with the loose coupling. The compensation circuits 115, 116 may have series-series (SS), series-parallel (SP), parallel-series (PS), parallel-parallel (PP), LC-S, and/or LCC-S topologies and so on, where the compensation circuits 115/116 may be electrically connected (directly and/or indirectly) with the transformer and/or receiver circuits in series or in parallel on the primary side or the secondary side. For example, if the compensation circuit is series-series, the compensation circuit on the primary side is electrically connected with a (transmitter) coil in transmitter pad 114 in series and the compensation circuit on the secondary side is electrically connected with a (receiver) coil in receiver pad 112 in series.

Referring to FIG. 1B, V_{AB} is the input voltage of the resonant network (output of an inverter) and V_{ab} represents the output voltage of the resonant network (input voltage of a rectifier). Iₚ and Iₛ are the input and output currents of the resonant network, respectively. Rₑ is the ac equivalent resistance of the output resistance Rₒ. Rₒ is the output equivalent resistance of charging the battery, which is the voltage Vₒ across the battery 106 divided by the output current Iₒ. The system 100 including the transmitter side subsystem 136 with transmitter compensation circuit 115 and the receiver side subsystem 138 with receiver compensation circuit 116. The transmitter-side subsystem 136 includes the transmitter 102. The system 100 includes a resonant network (or resonant tank) 119 as shown in FIG. 1B which includes resonant components. Resonant network 119 includes a transmitter side resonant network 119-t and a receiver side resonant network 119-r. As shown in FIG. 1B, transmitter side resonant network 119-t includes transmitter compensation circuit 115 and associated circuit components such as Lₚ (primary self-inductor), and receiver resonant network 119-r includes receiver compensation circuit 116 and associated circuit components such as Lₛ (secondary self-inductor). Receiver side subsystem 138 includes a rectifier 128 configured to convert the AC power output from the receiver 104 into DC output power 130. DC output power 130 is transmitted to battery 106 of battery-powered device 108 for charging the battery powered-device 108. Secondary AC power 125 has a voltage V_{ab} and a current Iₛ. The secondary AC power 125 is rectified (e.g., via rectifier 128) into DC output power 130 for transmission to the battery 106 of the battery-powered device 108. Voltage V_{ab} may be referred to as the secondary AC voltage V_{ab}. Current Iₛ may be referred to as the secondary AC current Iₛ. The transmitter side subsystem 136 further includes an inverter 120 configured to convert a DC power to an AC power at a relatively high frequency, such as in the range of kilohertz or greater. The AC power 124 output from the inverter 120 or the input power to the transmitter resonant network 119-t may be referred to as a primary AC power. Primary AC power 124 that is output from inverter 120 serves as an input AC power of the resonant network (or resonant tank) 119 as shown in FIG. 1B. The primary AC power has a voltage V_{AB}, and a primary AC current Iₚ. Voltage V_{AB} may be referred to as a primary AC voltage V_{AB}. Current Iₚ may be referred to as a primary AC current Iₚ. The DC power 122 input to the inverter 120 may be referred to as an input DC power 122 to the system 100. The input DC power 122 has a voltage Vᵢₙ and a current Iᵢₙ. The system 100 may receive power from a DC power supply. Alternatively, the system 100 receives AC power from power utility, where the AC power is converted to the input DC power 122 via an AC/DC converter. In some embodiments, a DC/DC converter (e.g., 135) may be used to change the voltage of the DC power output from the AC/DC converter to the voltage of the input DC power 122 to the inverter 120.

In the example embodiment, the system 100 further includes circuitry 132 configured to realize control of the charging system. Circuitry 132 includes controllers 134, processors 140, and memory devices 142. At least part of circuitry 132 is implemented on controllers 134. Circuitry 132 may further include sensors (not shown) for sensing voltage and/or current. Circuitry 132 may further include other components, such as circuitry for sensing other electrical parameters or operating the wireless IPT system, that enable the system 100 to function as described herein.

In the example embodiment, the controller 134 of system 100 may include a transmitter controller 134-t. The transmitter controller 134-t may be included in the charging station 110. The transmitter controller 134-t may be incorporated with the transmitter side subsystem 136 or positioned separately from the transmitter side subsystem 136. The transmitter controller 134-t provides control of the transmitter side subsystem 136, such as controlling the switching of the switches in the inverter 120.

In the example embodiment, the controller 134 of system 100 may include a receiver controller 134-r. The receiver controller 134-r may be positioned in the vehicle 108. The receiver controller 134-r may be incorporated with the receiver side subsystem 138 or positioned separately from the receiver side subsystem 138. The receiver controller 134-r is configured to control the operation of the receiver side subsystem 138, such as controlling the switching of the switches in the rectifier 128.

In the example embodiment, the transmitter controller 134-t communicates with the receiver controller 134-r. In some embodiments, instead of a transmitter controller 134-t and a receiver controller 134-r, the system 100 includes a master controller (not shown), which communicates with the transmitter side subsystem 136 and the receiver side subsystem 138 wirelessly, or via wired communication with one of the subsystems 136, 138 and via wireless communication with the other of subsystems 136, 138.

In the example embodiment, the controller 134 includes at least one processor-based microcontroller including a processor 140 and at least one memory device 142 wherein executable instructions, commands, and control algorithms, as well as data and information needed to satisfactorily operate the controller 134, are stored. The memory device 142 may be, for example, a random access memory (RAM), and other forms of memory used in conjunction with RAM memory, including but not limited to flash memory (FLASH), programmable read only memory (PROM), and electronically erasable programmable read only memory (EEPROM). Additionally, specific control software such as a firmware capable of operating the components in the manner described herein to bring about the beneficial charging as described herein is provided in/on the controllers, processors, and/or memory devices and able to be executed accordingly.

As used herein, the term “processor-based” microcontroller shall refer not only to controller devices including a processor or microprocessor as shown, but also to other equivalent elements such as microcomputers, programmable logic controllers, reduced instruction set circuits (RISC), application specific integrated circuits (ASIC), field programmable gate array (FPGA), and other programmable circuits, logic circuits, equivalents thereof, and any other circuit or processor capable of executing the functions described below. The processor-based devices listed above are examples only, and are thus not intended to limit in any way the definition and/or meaning of the term “processor-based.”

In operation, the input DC power 122 (Vᵢₙ, Iᵢₙ) is converted by the inverter 120 into the primary AC power 124 (V_{AB}, Iₚ). The primary AC power 124 is transmitted by the primary part of resonant network 119-t and received by the secondary part of resonant network 119-r. The receiver 104 outputs the secondary AC power (V_{ab}, Iₛ) 125. The secondary AC power 125 is rectified into the DC output power 130 and transmitted to the battery 106 of the battery-powered device 108 for charging.

The circuits of the system 100 were designed and/or operate according to various relationships and other parameters. The compensation network (e.g., 119) as disclosed herein works in resonant condition. Harmonic analysis can be used to analyze this condition, for example, by using first harmonic approximation (FHA). The V_{AB} and Vₒ quantities are square waves and the Iₚ and Iₛ quantities are sinusoidal waves. Vᵢₙ, Vₒ, Iᵢₙ and Iₒ are all direct current (DC) variables and V_{AB} and V_{ab}, and Iₚ and Iₛ are sinusoidal (e.g., alternating current, or AC) variables. The relationships between V_{AB} and Vᵢₙ, V_{ab} and Vₒ, Iᵢₙ and Iₚ, Iₒ and Iₛ are provided below.

$${I}_{o} = \frac{2 \sqrt{2}}{π} {I}_{s} ( where {I}_{o} ∝ {I}_{s} )$$

As shown by these expressions, V_{AB}, V_{ab}, Iₚ, and Iₛ are proportional to Vᵢₙ, Vₒ, Iᵢₙ, and Iₒ, respectively.

Another contemplation is reactive power. Ideally, reactive power is zero (0) to realize better heat/efficiency aspects. However, loosely coupled transformers in wireless IPT systems have significant leakage inductor problems. This affects transfer efficiency and component ratings. Compensation of reactive power is therefore necessary for the transfer of real power to the load side. The output voltage and current are functions of transformer parameters, switching frequency, and load impedance. Regarding conditions of zero reactive power, the relationship between input and output can be expressed by the following matrix (note the correlation between quantities A1, A2, and A3 in this matrix and FIG. 1B):

$$[ \begin{matrix}{V}_{AB} \\ {I}_{p}\end{matrix} ] = A \cdot [ \begin{matrix}{V}_{ab} \\ {I}_{s}\end{matrix} ] = A 1 \cdot A 2 \cdot A 3 \cdot [ \begin{matrix}{V}_{ab} \\ {I}_{s}\end{matrix} ] = [ \begin{matrix}{a}_{11} & {ja}_{12} \\ {ja}_{21} & {a}_{22}\end{matrix} ] \cdot [ \begin{matrix}{V}_{ab} \\ {I}_{s}\end{matrix} ]$$

Quantities a₁₁, a₁₂, a₂₁, a₂₂ are functions of resonant parameters, mutual inductance, and switching frequency.

Impedance is defined by the example relationships below:

$${R}_{e} = \frac{{V}_{ab}}{{I}_{s}}$$

$$and$$

$${Z}_{in} = \frac{{V}_{AB}}{{I}_{p}} = \frac{{a}_{11} \cdot {V}_{ab} + {ja}_{12} \cdot {I}_{s}}{{ja}_{21} \cdot {V}_{ab} + {a}_{22} \cdot {I}_{s}} = \frac{{a}_{11} \cdot {R}_{e} + {ja}_{12}}{{ja}_{21} \cdot {R}_{e} + {a}_{22}} = \frac{( {a}_{11} {a}_{22} + {a}_{12} {a}_{21} ) {R}_{e} + j ( {a}_{12} {a}_{22} - {a}_{11} {a}_{21} {R}_{e}^{2} )}{{a}_{22}^{2} + {a}_{21}^{2} {R}_{e}^{2}}$$

To achieve zero reactive power (e.g., Im(Zᵢₙ)=0), this means that:

a₁₂a₂₂−a₁₁a₂₁Rₑ²=0

where

a₁₂a₂₂=0

or

a₁₁a₂₁=0

and, based on the reciprocal theorem:

a₁₁a₂₂−ja₁₂·ja₂₁=1

which becomes:

a₁₁a₂₂+a₁₂a₂₁=1

When taking all of the above into consideration:

$${a}_{12} = 0 , {a}_{21} = 0 , {a}_{11} = \frac{1}{{a}_{22}}$$

$$and$$

$${a}_{11} = 0 , {a}_{22} = 0 , {a}_{12} = \frac{1}{{a}_{21}}$$

respectively resulting in:

$$[ \begin{matrix}{V}_{AB} \\ {I}_{p}\end{matrix} ] = [ \begin{matrix}{a}_{11} & 0 \\ 0 & {a}_{22}\end{matrix} ] \cdot [ \begin{matrix}{V}_{ab} \\ {I}_{s}\end{matrix} ] [ \begin{matrix}{V}_{AB} \\ {I}_{p}\end{matrix} ] = [ \begin{matrix}0 & {ja}_{12} \\ {ja}_{21} & 0\end{matrix} ] \cdot [ \begin{matrix}{V}_{ab} \\ {I}_{s}\end{matrix} ]$$

As described above, quantities a₁₁, a₁₂, a₂₁, a₂₂ are functions of resonant parameters, mutual inductance, and switching frequency. Taking the above into consideration, the solution of the techniques disclosed herein becomes apparent.

A principal diagonal topology as disclosed herein includes SS and PP topologies and similar topologies. This may include zero principal diagonal topologies or near-zero principal diagonal topologies. A secondary diagonal topology as disclosed herein include SP, PS, LC-S, and LCC-S topologies and similar topologies. This may include zero secondary diagonal topologies or near-zero secondary diagonal topologies.

When the principal diagonal is zero, there is a constant voltage expression between Iₚ and V_{ab}, where the following relationships become apparent.

$${a}_{11} = 0 , {a}_{22} = 0$$

$$and$$

$$[ \begin{matrix}{V}_{AB} \\ {I}_{p}\end{matrix} ] = [ \begin{matrix}0 & {ja}_{12} \\ {ja}_{21} & 0\end{matrix} ] \cdot [ \begin{matrix}{V}_{ab} \\ {I}_{s}\end{matrix} ]$$

meaning that

Iₚ=ja₂₁V_{ab}

which becomes

$${V}_{ab} = \frac{{I}_{p}}{{ja}_{21}} ( {V}_{ab} ∝ {I}_{p} , or {V}_{ab} ∝ {I}_{in} )$$

According to prior-defined relationships (V_{ab} ∝Vₒ, Iₚ ∝Iᵢₙ), Vₒ is proportional to Iₚ or Iᵢₙ. This means that Vₒ can be regulated by adjusting Iₚ or Iᵢₙ in a feedback loop. This shows a constant voltage characteristic.

The solution via the techniques herein provides for a zero principal diagonal as follows:

$${a}_{11} = 0 , {a}_{22} = 0$$

$$and$$

$$[ \begin{matrix}{V}_{AB} \\ {I}_{p}\end{matrix} ] = [ \begin{matrix}0 & {ja}_{12} \\ {ja}_{21} & 0\end{matrix} ] \cdot [ \begin{matrix}{V}_{ab} \\ {I}_{s}\end{matrix} ]$$

meaning that the constant current characteristic is:

V_{AB}=ja₁₂Iₛ

which becomes

$${I}_{s} = \frac{{V}_{AB}}{{ja}_{12}}$$

and the constant voltage characteristic is:

Iₚ=ja₂₁V_{ab}

which becomes

$${V}_{ab} = \frac{{I}_{p}}{{ja}_{21}}$$

When secondary diagonal is zero, the constant current expression between Iₚ and Iₛ is implied as well. In this case:

$${a}_{12} = 0 , {a}_{21} = 0$$

$$and$$

$$[ \begin{matrix}{V}_{AB} \\ {I}_{p}\end{matrix} ] = [ \begin{matrix}{a}_{11} & 0 \\ 0 & {a}_{22}\end{matrix} ] \cdot [ \begin{matrix}{V}_{ab} \\ {I}_{s}\end{matrix} ]$$

meaning that

Iₚ=a₂₂Iₛ

which becomes

$${I}_{s} = \frac{{I}_{p}}{{a}_{22}} ( {I}_{s} ∝ {I}_{p} , {I}_{s} ∝ {I}_{in} )$$

According to prior-defined relationships (Iₚ ∝Iᵢₙ, Iₛ ∝Iₒ, Iₒ is proportional to Iₚ or Iᵢₙ. This means that Io can be regulated by adjusting Iₚ or Iᵢₙ in a feedback loop. This shows a constant current characteristic.

The solution via the techniques herein provides for a zero secondary diagonal as follows:

$${a}_{12} = 0 , {a}_{21} = 0$$

$$and$$

$$[ \begin{matrix}{V}_{AB} \\ {I}_{p}\end{matrix} ] = [ \begin{matrix}{a}_{11} & 0 \\ 0 & {a}_{22}\end{matrix} ] \cdot [ \begin{matrix}{V}_{ab} \\ {I}_{s}\end{matrix} ]$$

meaning that the constant voltage characteristic is:

V_{AB}=a₁₁V_{ab}

which becomes

$${V}_{ab} = \frac{{V}_{AB}}{{a}_{11}}$$

and the constant current characteristic is:

Iₚ=a₂₂Iₛ

which becomes

$${I}_{s} = \frac{{I}_{p}}{{a}_{22}}$$

These topologies all can add using adjusting Iₚ or Iᵢₙ to realize CC or CV mode. When principal diagonal is zero such as in an SS topology, the current Iₒ (or Iₛ) will be regulated by adjusting Vᵢₙ (or V_{AB}) during CC and input voltage Vₒ (or V_{ab}) will be regulated by adjusting by Iᵢₙ (or Iₚ) during CV. When the secondary diagonal is zero such as in an LCC-S topology, the voltage Vₒ (or V_{ab}) will be regulated by adjusting Vᵢₙ (or V_{AB}) during CV and the current Iₒ (or Iₛ) will be regulated by adjusting Iᵢₙ (or Iₚ) during CC. In this manner current (Iᵢₙ Or Iₚ) can be used as a control variable/input control variable.

To compare, conventional techniques instead rely only on Vᵢₙ as the control variable. The conventional principal diagonal topology is defined by the following relationships:

$${a}_{11} = 0 , {a}_{22} = 0$$

$$and$$

$$[ \begin{matrix}{V}_{AB} \\ {I}_{p}\end{matrix} ] = [ \begin{matrix}0 & {ja}_{12} \\ {ja}_{21} & 0\end{matrix} ] \cdot [ \begin{matrix}{V}_{ab} \\ {I}_{s}\end{matrix} ]$$

which becomes:

V_{AB}=ja₁₂Iₛ

which then becomes:

$${I}_{s} = \frac{{V}_{AB}}{{ja}_{12}}$$

According to relationships described herein (V_{AB} ∝Vᵢₙ and Iₛ∝Iₒ, Iₒ is proportional to Vᵢₙ. This means that Iₒ can be regulated by adjusting Vᵢₙ in a feedback loop, showing a constant current characteristic. Vᵢₙ (V_{AB}) can be used as a control variable/input control variable.

The conventional secondary diagonal topology is defined by the following relationships.

$${a}_{12} = 0 , {a}_{21} = 0$$

$$and$$

$$[ \begin{matrix}{V}_{AB} \\ {I}_{p}\end{matrix} ] = [ \begin{matrix}{a}_{11} & 0 \\ 0 & {a}_{22}\end{matrix} ] \cdot [ \begin{matrix}{V}_{ab} \\ {I}_{s}\end{matrix} ]$$

which becomes:

V_{AB}=a₁₁V_{ab}

which then becomes:

$${V}_{ab} = \frac{{V}_{AB}}{{a}_{11}}$$

According to the relationships described herein (V_{AB}∝Vᵢₙ and V_{ab}∝Vₒ), Vₒ is proportional to Vᵢₙ. This means that Vₒ can be regulated by adjusting Vᵢₙ in a feedback loop, showing a constant voltage characteristic. These conventional topologies all only use adjusting Vᵢₙ to realize CC or CV mode in the principal diagonal topology or in the secondary diagonal topology, respectively. This means that they need to use hybrid topology.

FIGS. 1C and 1D show conventional IPT circuit designs. FIG. 1C is a conventional IPT circuit 170. FIG. 1D is a conventional IPT circuit 172. Conventional topology techniques all only use adjusting Vᵢₙ as control to realize CC or CV mode. In the actual topologies, it is very hard to find the two sets of the parameters which can make a₁₁, a₂₂ and a₁₂, a₂₁ zero, respectively. To achieve CC and CV, conventional techniques use hybrid topologies. During CC charging, the topology which has CC character are switched and then during CV charging, the CV topology are switched. FIG. 1C (prior art) shows a hybrid SS and LC-S compensated converter 170, where switch S1 is “on” and switches S2 and S3 are “off” in the SS topology, and switches S2 and S3 are “on” and S1 is “off” in the LC-S topology. FIG. 1D (prior art) shows a hybrid SS and LCC-S compensated converter 172, where switch S2 is “on” and switches S1 and S3 are “off” in the SS topology, and switches S1 and S3 are “on” and S2 is “off” in the LCC-S topology. The extra switches (e.g., S1-S3) shown in FIGS. 1C and 1D cause both the circuit structure and control to be complicated and increases costs.

In the actual application of the present techniques, the principal diagonal or secondary diagonal cannot equal zero completely. One reason is parameter tolerance. But the more important reason is the requirement of Zero Voltage Switching (ZVS, which can improve efficiency and is better than EMC). ZVS requires that the resonant tank shows as inductive (e.g., the Iₚ should lag V_{AB} by a very small angle). The relationship matrix in the actual application is defined by the following example relationships.

In a principal diagonal topology such as an SS topology, principal diagonal is zero as defined by the following relationships:

$${a}_{11} = 0 , {a}_{22} = 0$$

$$and$$

$$[ \begin{matrix}{V}_{AB} \\ {I}_{p}\end{matrix} ] = [ \begin{matrix}0 & {ja}_{12} \\ {ja}_{21} & 0\end{matrix} ] \cdot [ \begin{matrix}{V}_{ab} \\ {I}_{s}\end{matrix} ]$$

which becomes

$$[ \begin{matrix}{V}_{AB} \\ {I}_{p}\end{matrix} ] = [ \begin{matrix}{a}_{11} & {ja}_{12} \\ {ja}_{21} & {a}_{22}\end{matrix} ] \cdot [ \begin{matrix}{V}_{ab} \\ {I}_{s}\end{matrix} ]$$

$$where$$

$$\vert {a}_{12} \vert ≫ \vert {a}_{11} \vert , \vert {a}_{21} \vert ≫ \vert {a}_{22} \vert$$

and
a₁₁,a₂₂ are close to zero (one of a₁₁,a₂₂ can be zero, but cannot be zero together for ZVS).

### Additionally:

V_{AB}=ja₁₂Iₛ+a₁₁V_{ab}

which becomes

$${I}_{s} = \frac{{V}_{AB} - {a}_{11} {V}_{ab}}{{ja}_{12}}$$

The relationship between Iₛ (Iₒ) and V_{AB} (Vᵢₙ) is still monotonous.

### Further:

Iₚ=ja₂₁V_{ab}+a₂₂Iₛ

which becomes

$${V}_{ab} = \frac{{I}_{p} - {a}_{22} {I}_{s}}{{ja}_{21}}$$

The relationship between V_{ab} (Vₒ) and Iₚ (Iᵢₙ) is still monotonous.

As such, Vₒ (or V_{ab}) or Iₒ (or Iₛ) can be regulated by adjusting Iₚ (or Iᵢₙ) or by adjusting Vᵢₙ (or V_{AB}) in the actual application of the principal diagonal topology. The monotonous relationships mean these quantities can be regulated with close loop techniques. One of a₁₁ or a₂₂ can be zero, but cannot be zero together.

In a secondary diagonal topology such as an LCC-S topology, the secondary diagonal is zero as defined by the following relationships:

$${a}_{12} = 0 , {a}_{21} = 0$$

$$and$$

$$[ \begin{matrix}{V}_{AB} \\ {I}_{p}\end{matrix} ] = [ \begin{matrix}{a}_{11} & 0 \\ 0 & {a}_{22}\end{matrix} ] \cdot [ \begin{matrix}{V}_{ab} \\ {I}_{s}\end{matrix} ]$$

meaning that

$$[ \begin{matrix}{V}_{AB} \\ {I}_{p}\end{matrix} ] = [ \begin{matrix}{a}_{11} & {ja}_{12} \\ {ja}_{21} & {a}_{22}\end{matrix} ] \cdot [ \begin{matrix}{V}_{ab} \\ {I}_{s}\end{matrix} ]$$

$$where$$

$$\vert {a}_{11} \vert ≫ \vert {a}_{12} \vert , \vert {a}_{22} \vert ≫ \vert {a}_{21} \vert$$

and
a₁₂,a₂₁ are close to zero (one of a₁₂,a₂₁ can be zero, but cannot be zero together for ZVS).

### Additionally:

V_{AB}=a₁₁V_{ab}+ja₁₂Iₛ

which becomes

$${V}_{ab} = \frac{{V}_{AB} - {ja}_{22} {I}_{s}}{{a}_{11}}$$

The relationship between V_{ab} (Vₒ) and V_{AB} (Vᵢₙ) is still monotonous.

Further:

Iₚ=a₂₂Iₛ+ja₂₁V_{ab}

which becomes

$${I}_{s} = \frac{{I}_{p} - {ja}_{21} {V}_{ab}}{{a}_{22}}$$

The relationship between Iₛ(Iₒ) and Iₚ(Iᵢₙ) is still monotonous.

As such, Vₒ (or V_{ab}) or Iₒ (or Iₛ) can be regulated by adjusting Vᵢₙ (or V_{AB}) or by adjusting Iₚ (or Iᵢₙ) in the actual application of the secondary diagonal topology. The monotonous relationships mean these quantities can be regulated with close loop techniques. One of a₁₂ or a₂₁ can be zero, but cannot be zero together.

FIG. 1E is an example of a compensation circuit topology configuration for circuit 115 and/or circuit 116, specifically an SS topology. Capacitors Cₚ and Cₛ are compensating capacitors. An example relationship matrix for FIG. 1E is as follows:

$$[ \begin{matrix}{V}_{AB} \\ {I}_{p}\end{matrix} ] = [ \begin{matrix}\frac{{L}_{p}}{M} - \frac{1}{{ω}^{2} {MC}_{p}} & j \frac{{ω}^{2} {L}_{p} {L}_{s} + \frac{1}{{ω}^{2} {C}_{p} {C}_{s}} - \frac{{L}_{p}}{{C}_{s}} - \frac{{L}_{s}}{{C}_{p}} - {ω}^{2} {M}^{2}}{ω M} \\ - j \frac{1}{ω M} & \frac{{L}_{s}}{M} - \frac{1}{{ω}^{2} {MC}_{s}}\end{matrix} ] \cdot [ \begin{matrix}{V}_{ab} \\ {I}_{s}\end{matrix} ]$$

$$= [ \begin{matrix}{a}_{11} & {ja}_{12} \\ {ja}_{21} & {a}_{22}\end{matrix} ] \cdot [ \begin{matrix}{V}_{ab} \\ {I}_{s}\end{matrix} ] = [ \begin{matrix}{a}_{11} & {ja}_{12} \\ {ja}_{21} & {a}_{22}\end{matrix} ] \cdot [ \begin{matrix}{V}_{ab} \\ {I}_{s}\end{matrix} ]$$

In this topology, the principal diagonal is close to zero (e.g., near-zero).

FIGS. 1F and 1G are a high-level circuit diagram for an example SS circuit topology in CC mode of the embodiment shown in FIG. 1B, where FIG. 1G focuses on switching frequency aspects.

FIG. 1F is defined by the example relationships of:

$$[ \begin{matrix}{V}_{AB} \\ {I}_{p}\end{matrix} ] = [ \begin{matrix}\frac{{L}_{p}}{M} - \frac{1}{{ω}^{2} {MC}_{p}} & j \frac{{ω}^{2} {L}_{p} {L}_{s} + \frac{1}{{ω}^{2} {C}_{p} {C}_{s}} - \frac{{L}_{p}}{{C}_{s}} - \frac{{L}_{s}}{{C}_{p}} - {ω}^{2} {M}^{2}}{ω M} \\ - j \frac{1}{ω M} & \frac{{L}_{s}}{M} - \frac{1}{{ω}^{2} {MC}_{s}}\end{matrix} ] \cdot [ \begin{matrix}{V}_{ab} \\ {I}_{s}\end{matrix} ]$$

$$= [ \begin{matrix}{a}_{11} & {ja}_{12} \\ {ja}_{21} & {a}_{22}\end{matrix} ] \cdot [ \begin{matrix}{V}_{ab} \\ {I}_{s}\end{matrix} ]$$

$$and$$

$${I}_{s} = \frac{{V}_{AB} - {a}_{11} {V}_{ab}}{{ja}_{12}}$$

In CC mode, the expression

$$\frac{{V}_{AB} - {a}_{11} {V}_{ab}}{{ja}_{12}}$$

needs to be kept constant to realize constant Iₛ(Iₒ). V_{AB} is the input voltage of the resonant network (e.g., the output of the inverter). On the primary side, this can be realized as a voltage controlled voltage source (VCVS). The input is Vᵢₙ and output is V_{AB} in the VCVS.

The circuit of FIG. 1F is defined by the following example relationships:

$$[ \begin{matrix}{V}_{AB} \\ {I}_{p}\end{matrix} ] = [ \begin{matrix}0 & - j {ω}_{cc} M \\ - j \frac{1}{{ω}_{cc} M} & \frac{{L}_{s}}{M} - \frac{1}{{ω}_{cc}^{2} {MC}_{s}}\end{matrix} ] \cdot [ \begin{matrix}{V}_{ab} \\ {I}_{s}\end{matrix} ]$$

$${I}_{s} = \frac{{V}_{AB}}{- j {ω}_{cc} M}$$

$${ω}_{cc} = \frac{1}{\sqrt{{L}_{p} {C}_{p}}} < \frac{1}{\sqrt{{L}_{s} {C}_{s}}}$$

If the switching frequency meets

$${ω}_{cc} = \frac{1}{\sqrt{{L}_{p} {C}_{p}}} < \frac{1}{\sqrt{{L}_{s} {C}_{s}}} ,$$

the Iₛ quantity is only related with V_{AB} (see highlighted Cs in FIG. 1G).

FIGS. 1H and 1I are a high-level circuit diagram for an example SS circuit topology in CV mode of the embodiment shown in FIG. 1B, where FIG. 1I focuses on switching frequency.

The circuit of FIG. 1H is defined by the following example relationships:

$$[ \begin{matrix}{V}_{AB} \\ {I}_{p}\end{matrix} ] = [ \begin{matrix}\frac{{L}_{p}}{M} - \frac{1}{{ω}^{2} {MC}_{p}} & j \frac{{ω}^{2} {L}_{p} {L}_{s} + \frac{1}{{ω}^{2} {C}_{p} {C}_{s}} - \frac{{L}_{p}}{{C}_{s}} - \frac{{L}_{s}}{{C}_{p}} - {ω}^{2} {M}^{2}}{ω M} \\ - j \frac{1}{ω M} & \frac{{L}_{s}}{M} - \frac{1}{{ω}^{2} {MC}_{s}}\end{matrix} ] \cdot [ \begin{matrix}{V}_{ab} \\ {I}_{s}\end{matrix} ]$$

$$= [ \begin{matrix}{a}_{11} & {ja}_{12} \\ {ja}_{21} & {a}_{22}\end{matrix} ] \cdot [ \begin{matrix}{V}_{ab} \\ {I}_{s}\end{matrix} ]$$

$$and$$

$${V}_{ab} = \frac{{I}_{p} - {a}_{22} {I}_{s}}{{ja}_{21}}$$

In CV mode, the expression

$$\frac{{I}_{p} - {a}_{22} {I}_{s}}{{ja}_{21}}$$

needs to pe kept constant to realize constant V_{ab} (Vₒ). Note, Iₚ is input current of the resonant network. On the primary, this is a voltage controlled current source (VCCS). The input is Vᵢₙ and output is Iₚ in the VCCS.

The circuit of FIG. 1I is defined by the following example relationships:

$$[ \begin{matrix}{V}_{AB} \\ {I}_{p}\end{matrix} ] = [ \begin{matrix}0 & - j {ω}_{cc} M \\ - j \frac{1}{{ω}_{cc} M} & \frac{{L}_{s}}{M} - \frac{1}{{ω}_{cc}^{2} {MC}_{s}}\end{matrix} ] \cdot [ \begin{matrix}{V}_{ab} \\ {I}_{s}\end{matrix} ]$$

$${V}_{ab} = {I}_{p} \cdot j {ω}_{cv} M$$

$${ω}_{cv} = \frac{1}{\sqrt{{L}_{s} {C}_{s}}} > \frac{1}{\sqrt{{L}_{p} {C}_{p}}}$$

If the switching frequency meets

$${ω}_{cv} = \frac{1}{\sqrt{{L}_{s} {C}_{s}}} > \frac{1}{\sqrt{{L}_{p} {C}_{p}}} ,$$

the quantity V_{ab} is only related with Iₚ (as is apparent from the lack of the elements Lₛ and Cₛ in FIG. 1I as compared to FIG. 1H).

FIG. 1J illustrates an alternative topology to the above-discussed SS topology. FIG. 1J is an LCC-S topology, as indicated by the Lₓ, Cₚₛ, and Cₚₚ compensation components on the left side (near V_{AB}) and the Cₛ compensation component on the right side (near V_{ab}). This LCC-S topology is defined by the example relationship matrix below:

$$[ \begin{matrix}{V}_{AB} \\ {I}_{p}\end{matrix} ] =$$

$$[ \begin{matrix}\frac{( {L}_{x} + {L}_{p} ) - \frac{1}{{ω}^{2} {C}_{ps}} - {ω}^{2} {L}_{x} {L}_{p} {C}_{pp}}{M} & j [ \frac{ω ( {L}_{x} + {L}_{p} ) - \frac{1}{ω {C}_{ps}} + ω {L}_{x} \frac{{C}_{pp}}{{C}_{ps}} - {ω}^{3} {L}_{x} {L}_{p} {C}_{pp}}{ω M} \cdot ( ω {L}_{s} - \frac{1}{ω {C}_{s}} ) - ω M ( 1 - {ω}^{2} {L}_{x} {C}_{pp} ) ] \\ j \frac{{ω}^{2} {L}_{p} {C}_{pp} - 1 - \frac{{C}_{pp}}{{C}_{ps}}}{ω M} & \frac{1 + \frac{{C}_{pp}}{{C}_{ps}} - {ω}^{2} {L}_{p} {C}_{pp}}{ω M} \cdot ( ω {L}_{s} - \frac{1}{ω {C}_{s}} ) + {ω}^{2} {MC}_{pp}\end{matrix} ] .$$

$$[ \begin{matrix}{V}_{ab} \\ {I}_{s}\end{matrix} ] = [ \begin{matrix}{a}_{11} & {ja}_{12} \\ {ja}_{21} & {a}_{22}\end{matrix} ] \cdot [ \begin{matrix}{V}_{ab} \\ {I}_{s}\end{matrix} ] = [ \begin{matrix}{a}_{11} & {ja}_{12} \\ {ja}_{21} & {a}_{22}\end{matrix} ] \cdot [ \begin{matrix}{V}_{ab} \\ {I}_{s}\end{matrix} ]$$

The LCC-S topology of FIG. 1J has a similar relationship matrix as the SS topology in FIGS. 1C-1G. In this topology, the secondary diagonal is close to zero (e.g., near-zero).

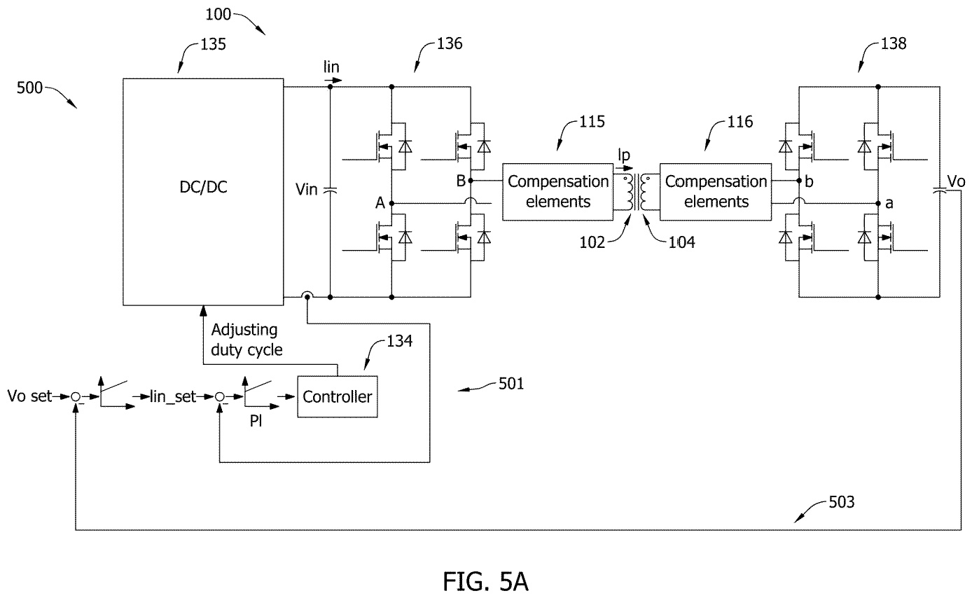

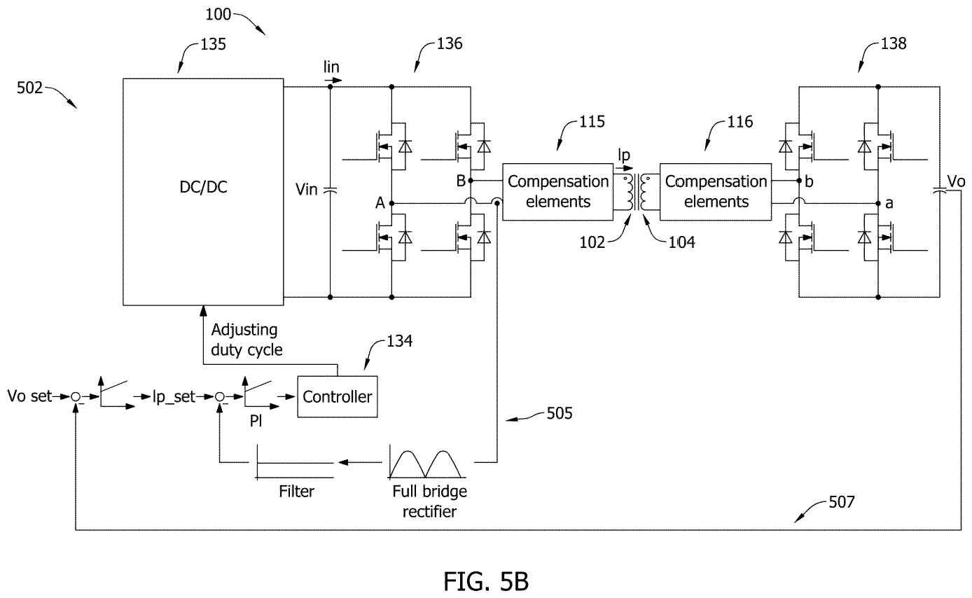

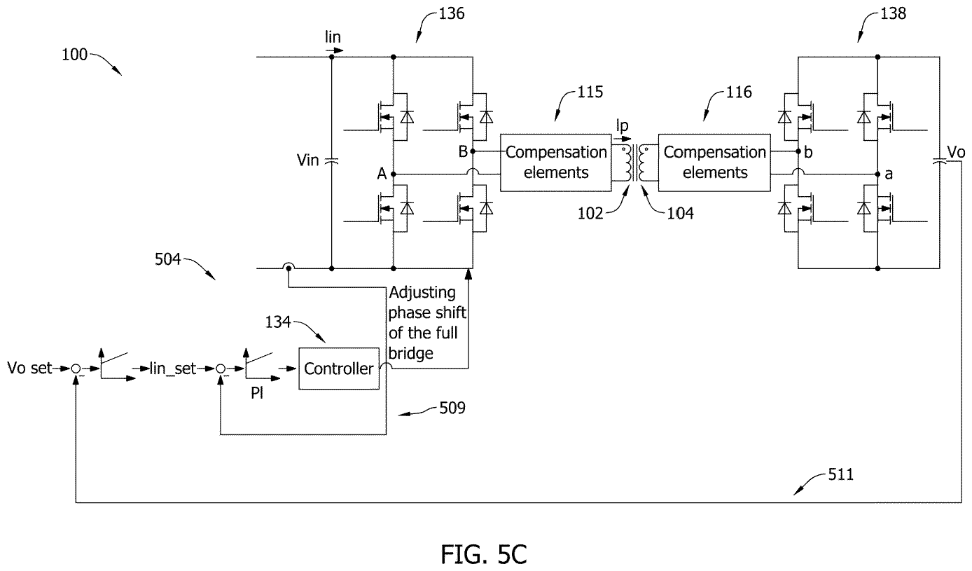

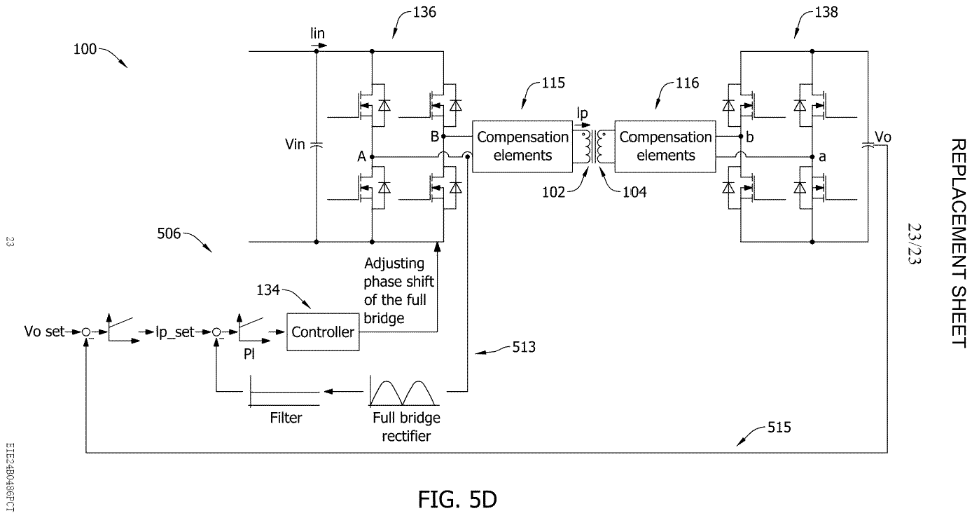

FIG. 1K shows aspects of an example transmitter (e.g., 102) as disclosed herein. The transmitter may include various stages including a power factor correction (PFC) stage 137a, a DC/DC converter stage 137b (see also FIGS. 5A, 5B, and DC/DC converter 135), an inverter stage 137c (see also FIG. 1B and inverter 120), and a resonant tank (primary side) stage 137d (see also FIG. 1B and resonant network 119-t).

FIG. 1L shows a graph 139 illustrating aspects of the inverter output 161, charting V_{AB} over time. The DC/DC stage (e.g., 137b) can be used to adjust V_{AB}. In doing so, the inverter's output may have a cycle pattern as shown in FIG. 1L. The amplitude of V_{AB} is the same as Vᵢₙ. V_{AB} is adjusted by its amplitude (Vᵢₙ) (the output of the DC/DC converter) for its switching cycle (fixed to 50%). See switching cycle (Ts) in FIG. 1L.

FIG. 1M is a graph 141 illustrating aspects of phase angle 162 shift adjusting V_{AB}. Vᵢₙ is fixed by the output of the PFC stage. The phase angle is related to the width of the V_{AB}. V_{AB} is adjusted by its pulse wide (the phase shift angle) for its amplitude is fixed. The corresponding circuit section 143 is also shown in FIG. 1M (see also FIGS. 5A-5D).

FIG. 1N is a method 150 according to embodiments disclosed herein. Step 152 includes operating the wireless IPT system to use output current (Iₒ) and/or voltage (Vₒ) as a control variable using techniques described herein. Step 154 includes utilizing a relevant voltage (Vᵢₙ or V_{AB}) and/or current (Iᵢₙ or Iₚ) in a principal diagonal topology (e.g., SS) or relevant current (Iᵢₙ or Iₚ)/voltage (Vᵢₙ or V_{AB}) in a secondary diagonal topology (e.g., LCC-S) in the transmitter as a reference of the second loop using techniques described herein. Step 156 includes the step of switching to a different charging mode (e.g., CC/CV) via the control operations disclosed herein. Step 158 includes the step of acquiring a desired output current (Iₒ) and/or voltage (Vₒ) using techniques disclosed herein. Step 159 includes the step of finishing the charging process of a battery by selecting the appropriate CC/CV charging mode to ensure safe and efficient charging of the battery using techniques disclosed herein.

To charge a device 108, the device 108 moves to the charging station 110 and the receiver pad 112 of the device 108 is placed adjacent to the transmitter pad 114. A gap 160 (see FIG. 1A) exists between the pads 112, 114. The device 108 establishes communication with the charging station 110 via the controllers 134. A mutual inductance M may exist between the transmitter 102 and the receiver 104. The control and operation parameters, such as input power, may be adjusted based on various parameters such as mutual inductance M (see FIG. 1B).

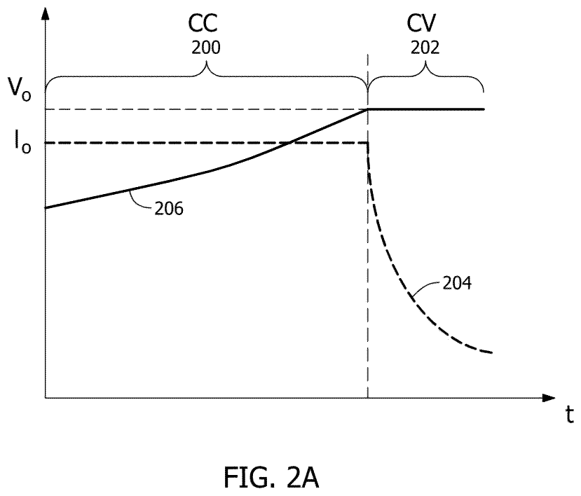

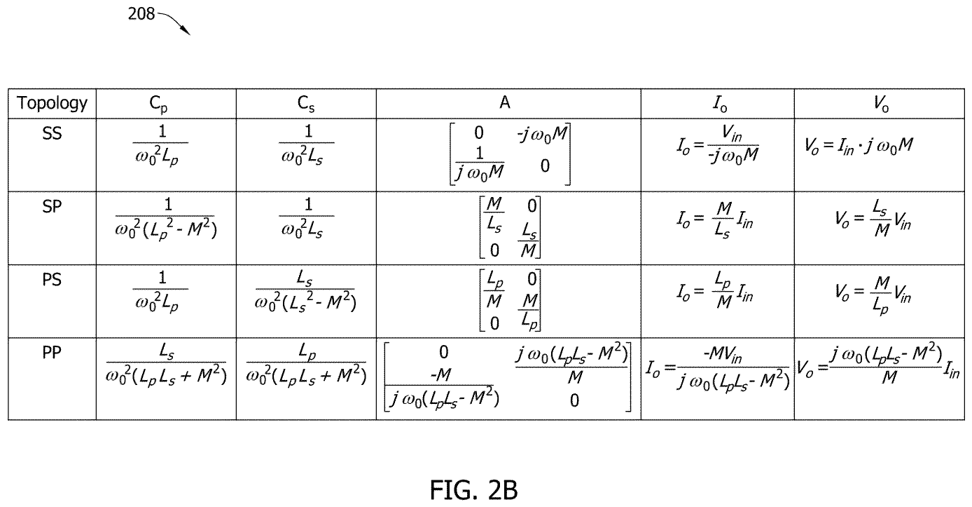

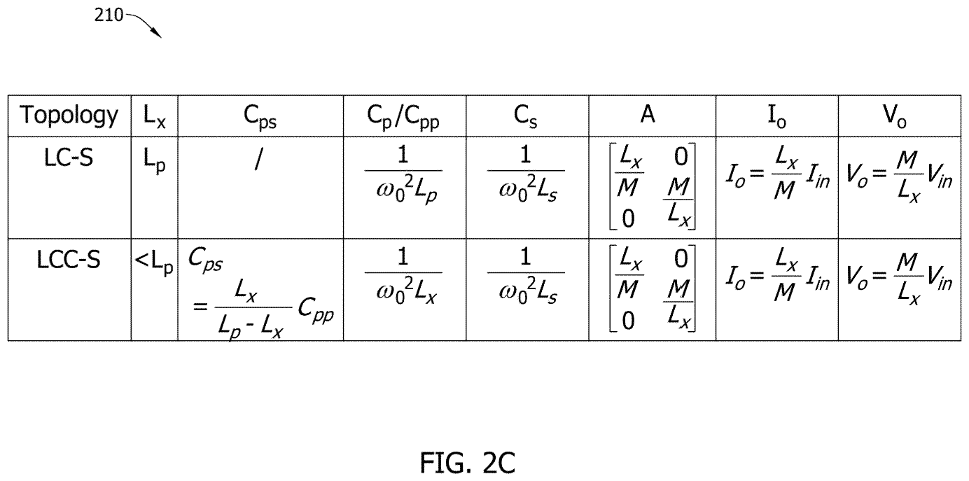

FIG. 2A is a voltage/current vs. time graph showing the CC and CV being targeted by the techniques disclosed herein for battery charging. Generally, there are two stages for battery charging: (i) constant current (CC) charging and (ii) constant voltage (CV) charging. Most of the energy is delivered from charger to the battery during CC mode, and as such the period of CC is typically much longer than that of CV.

During CC mode 200, the output current (Iₒ) of the charger will be regulated by the controller (e.g., 134). The controller will maintain the output current equal to the target current by a feedback loop. In this period, the output current of the charger is constant and the output voltage of the charger (Vₒ) will increase gradually, as illustrated by the Iₒ curve 204 and the Vₒ curve 206 in FIG. 2A.

During CV mode 202, the output voltage (Vₒ) of the charger will be regulated by the controller (e.g., 134). The controller will maintain the output voltage equal to the target voltage by a feedback loop. In this period, the output voltage of the charger is constant and the output current of the charger will reduce gradually, as illustrated by the Iₒ curve 204 and the Vₒ curve 206 in FIG. 2A.

FIGS. 2B and 2C are tables of parameters for the various topologies disclosed herein. Table 208 in FIG. 2B lists Cₚ, Cₛ, A, Iₒ, and Vₒ parameters for each of the SS, SP, PS, and PP topologies disclosed herein. Table 210 in FIG. 2C lists Lₓ, Cₚₛ, Cₚ/Cₚₚ, A, Iₒ, and Vₒ parameters for each of the LC-S and LCC-S topologies disclosed herein. Principal diagonal topologies include the SS and PP topologies. Secondary diagonal topologies include the SP, PS, LC-S and LCC-S topologies. Primary compensation capacitor Cₚ is electrically connected in series or in parallel with the transmitter coil. The receiver compensation circuit 116 includes a secondary compensation capacitor Cₛ electrically connected in series or in parallel with the receiver coil. The quantity ω is the operating angular frequency of the system 100 and is the switching angular frequency of the switches in the inverter 120.

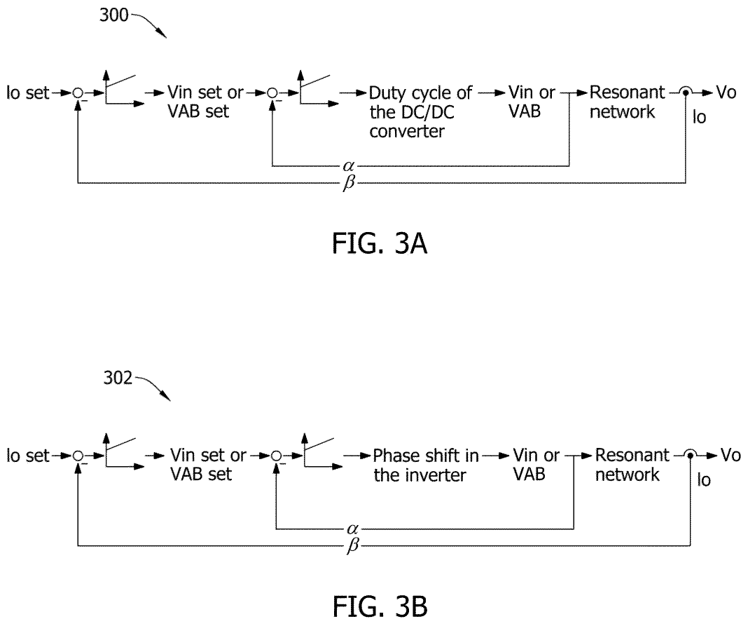

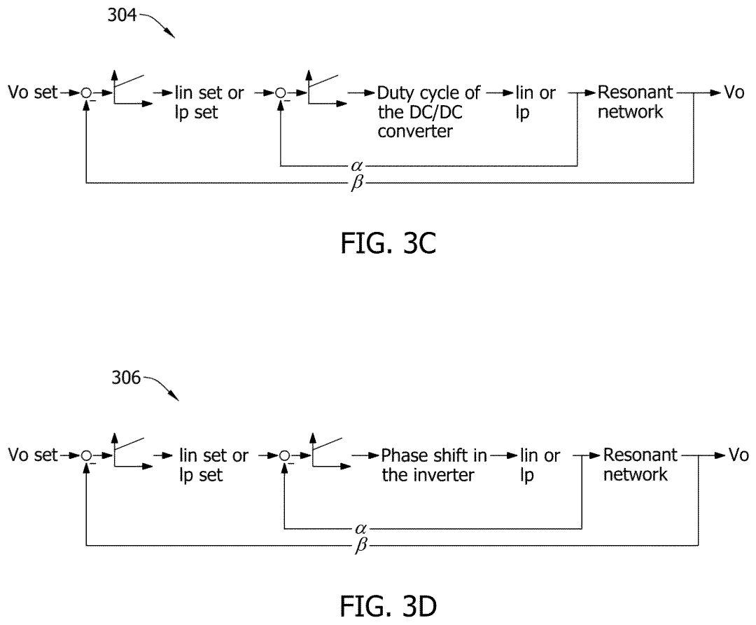

FIGS. 3A-3D are block diagrams of example embodiments using principal diagonal topology (e.g., SS topology). FIGS. 3A and 3B are block diagrams of an example CC mode using principal diagonal topology (e.g., SS topology), to be viewed in conjunction with the embodiments of FIGS. 1A and 1B. FIGS. 3A and 3B use Vᵢₙ or V_{AB} as a second control variable in CC mode. FIG. 3A is a block diagram 300 of an example CC mode with a DC/DC stage before an inverter in the example embodiment of the system shown in FIG. 1B. If there is a DC/DC converter (e.g., 135) before the inverter (e.g., 120), Iₒ (Iₛ) can be regulated by adjusting Vᵢₙ or V_{AB}. The inverter works at 180 degrees output of phase. FIG. 3B is a block diagram 302 of an example CC mode without a DC/DC stage before an inverter in the example embodiment of the system shown in FIG. 1B. If there is no DC/DC converter before the inverter, that means the Vᵢₙ is constant. The inverter works in phase shift mode, and phase shift can be used to control the V_{AB} of the inverter to realize CC mode. Quantities α and β in FIGS. 3A and 3B represent sensors, where α is a sensor of Vᵢₙ (V_{AB}) and β is a sensor of Iₒ. FIGS. 3C and 3D are block diagrams of an example CV mode using principal diagonal topology (e.g., SS topology), to be viewed in conjunction with the embodiments of FIGS. 1A and 1B. FIG. 3C is a block diagram 304 of an example CV mode with a DC/DC stage before an inverter in the example embodiment of the system shown in FIG. 1B. If there is a DC/DC converter (e.g., 135) before the inverter (e.g., 120), Vₒ (V_{AB}) can be regulated by adjusting Iᵢₙ or Iₚ. The inverter works at 180 degrees output of phase. FIG. 3D is a block diagram 306 of an example CV mode without a DC/DC stage before an inverter in the example embodiment of the system shown in FIG. 1B. If there is no DC/DC converter (e.g., 135) before the inverter (e.g., 120), that means Vᵢₙ is constant. The inverter works in phase shift mode, and phase shift can be used to control the Iᵢₙ or Iₚ of the inverter. As for the Iₚ sinusoidal wave, it can be rectified first and then filtered to get the mean value or peak value (see FIGS. 5B and 5D illustrating rectifying and filtering), using the mean value or peak value of the absolute value of Iₚ to realize CV mode. Quantities α and β in FIGS. 3C and 3D represent sensors, where α is a sensor of Iᵢₙ (Iₚ) and β is a sensor of Vₒ.

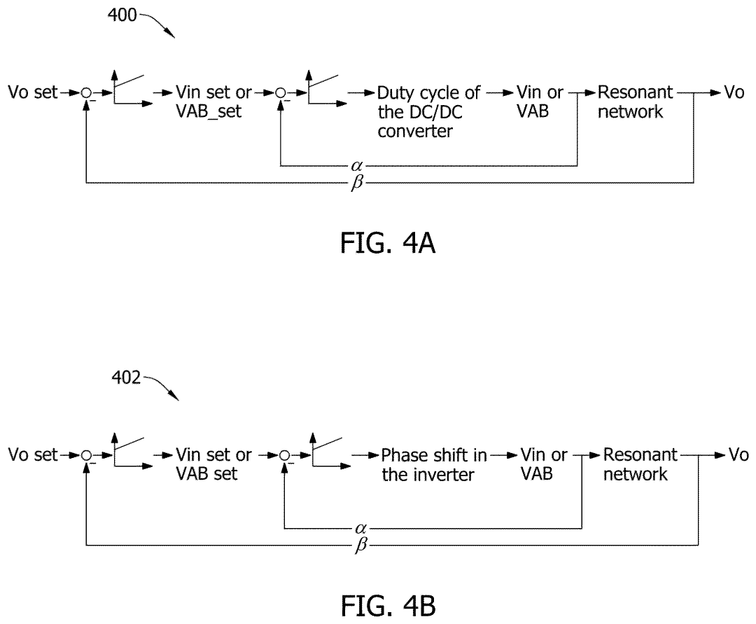

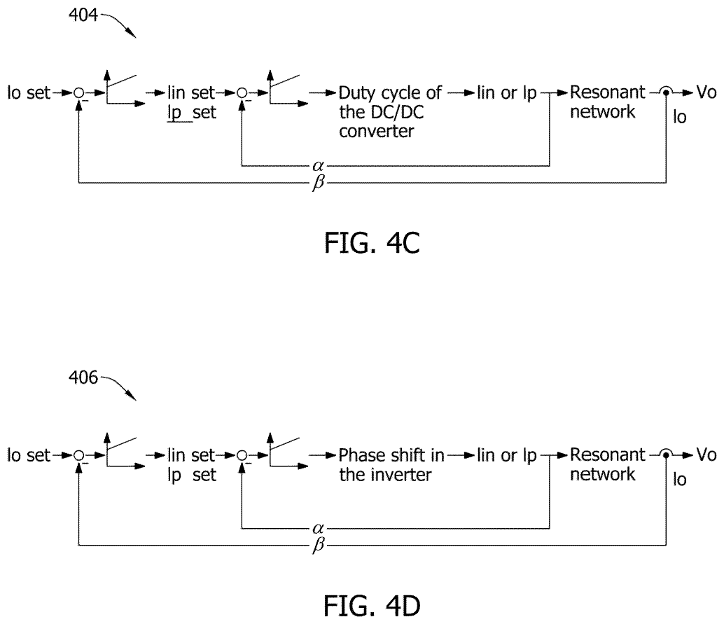

FIGS. 4A-4D are block diagrams of example embodiments using secondary diagonal topology (e.g., LCC-S topology). FIGS. 4A and 4B are block diagrams of an example CV mode using secondary diagonal topology (e.g., LCC-S topology), to be viewed in conjunction with the embodiments of FIGS. 1A and 1B. FIG. 4A is a block diagram 400 of an example CV mode with a DC/DC stage before an inverter in the example embodiment of the system shown in FIG. 1B. If there is a DC/DC converter (e.g., 135) before the inverter (e.g., 120), Vₒ (V_{ab}) can be regulated by adjusting Vᵢₙ or V_{AB}. The inverter works at 180 degrees output of phase. FIG. 4B is a block diagram 402 of an example CV mode without a DC/DC stage before an inverter in the example embodiment of the system shown in FIG. 1B. If there is no DC/DC converter (e.g., 135) before the inverter (e.g., 120), the inverter works in phase shift mode, and phase shift can be used to control the V_{AB} of the inverter. Quantities α and β in FIGS. 4A and 4B represent sensors, where α is a sensor of Vᵢₙ (V_{AB}) and β is a sensor of Vₒ. FIGS. 4C and 4D are block diagrams of an example CC mode using secondary diagonal topology (e.g., LCC-S topology) to be viewed in conjunction with the embodiments of FIGS. 1A and 1B. FIG. 4C is a block diagram 404 of an example CC mode with a DC/DC stage before an inverter in the example embodiment of the system shown in FIG. 1B. If there is a DC/DC converter (e.g., 135) before the inverter (e.g., 120), Iₒ (Iₛ) can be regulated by adjusting Iᵢₙ or Iₚ. The inverter works at 180 degrees output of phase. FIG. 4D is a block diagram 406 of an example CC mode without a DC/DC stage before an inverter in the example embodiment of the system shown in FIG. 1B. If there is no DC/DC converter (e.g., 135) before the inverter (e.g., 120), the inverter works in phase shift mode, and phase shift can be used to control the Iᵢₙ or Iₚ of the inverter to realize CC mode. Quantities α and β in FIGS. 4C and 4D represent sensors, where α is a sensor of Iᵢₙ (Iₚ) and β is a sensor of Iₒ.

In a preferred embodiment, the techniques in FIGS. 3A and 3B where the second control variable is Vᵢₙ or V_{AB} in CC mode, plus the techniques in FIGS. 3C and 3D where the second control variable is Iᵢₙ or Iₚ in CV mode, realizes CC and CV in principal diagonal topology (e.g., SS topology).

In another preferred embodiment, the techniques in FIGS. 4A and 4B where the second control variable is Vᵢₙ or V_{AB} in CV mode, plus the techniques in FIGS. 4C and 4D where the second control variable is Iᵢₙ or Iₚ in CC mode, realizes CC and CV in secondary diagonal topology (e.g., LCC-S topology).

As such, the CC mode is configurable in either principal diagonal topology such as an SS principal diagonal topology or secondary diagonal topology such as an LCC-S secondary diagonal topology, and the CV mode is configurable in either principal diagonal topology such as an SS principal diagonal topology or secondary diagonal topology such as an LCC-S secondary diagonal topology, usable in configurations disclosed herein to bring about desired entering into and/or switching to/from CC/CV modes. These techniques represent improvements over conventional techniques and improvements to the technical field of battery charging, as both the circuit design and circuit control (e.g., via software) are improved. For example, firmware associated with the circuit(s) can be configured to perform switching between the CC/CV modes in a smoother manner than conventional switching (e.g., less losses).

FIGS. 5A-5D are schematics for example feedback loops (see also FIGS. 3A, 3B). These feedback loops can function as control loops (e.g., inner and outer control loops). FIG. 5A is a schematic for an example feedback loop configuration 500 using Iᵢₙ as feedback in CV mode with a DC/DC stage (e.g., 137b) and DC/DC converter (e.g., 135) before an inverter (e.g., 120) in accordance with embodiments disclosed herein. This allows for closing of the loop by Iᵢₙ. Vᵢₙ can be regulated by adjusting Iᵢₙ to realize CV mode. See inner loop 501 and outer loop 503 in FIG. 5A. FIG. 5B is a schematic for an example feedback loop configuration 502 using Iₚ as feedback in CV mode with a DC/DC stage (e.g., 137b) and DC/DC converter (e.g., 135) before an inverter (e.g., 120) in accordance with embodiments disclosed herein. This allows for closing of the loop by Iₚ. Vᵢₙ can be regulated by adjusting Iₚ to realize CV mode. See inner loop 505 and outer loop 507 in FIG. 5B. FIG. 5C is a schematic for an example feedback loop configuration 504 using Iᵢₙ as feedback in CV mode with a phase shift full bridge in accordance with embodiments disclosed herein. There is no DC/DC converter before the inverter. See inner loop 509 and outer loop 511 in FIG. 5C. FIG. 5D is a schematic for an example feedback loop configuration 506 using Iₚ as feedback in CV mode with a phase shift full bridge in accordance with embodiments disclosed herein. There is no DC/DC converter before the inverter. See inner loop 513 and outer loop 515 in FIG. 5D. With respect to outer loops 503, 507, 511, and 515, a first control variable (e.g., Vₒ or Iₒ) may serve as the reference for the outer loops 503, 507, 511, and 515 (see also step 152 in FIG. 1N). Loops 503, 507, 511, and 515 may also be referred to as first control loops. With respect to inner loops 501, 505, 509, and 513, the second control variable may serve as the reference for the inner loops 501, 505, 509, and 513 (e.g., (i) in principal diagonal topology, the second control variable is Vᵢₙ or V_{AB} in CC mode, Iᵢₙ or Iₚ in CV mode; (ii) in secondary diagonal topology, the second control variable is Vᵢₙ Or V_{AB} in CV mode, Iᵢₙ or Iₚ in CC mode) (see also step 154 in FIG. 1N). Loops 501, 505, 509, and 513 may also be referred to as second control loops.

FIGS. 5A and 5B correspond to FIG. 3C, and FIGS. 5C and 5D correspond to FIG. 3D. Figures that match the relationships of how FIGS. 5A and 5B correspond to FIG. 3C and how FIGS. 5C and 5D correspond to FIG. 3D can also be prepared with respect to FIGS. 3A, 3B, 4A, 4B, 4C, and 4D. These additional figures (not shown) and their respective contents can be relied upon herein in the same manner as FIGS. 5A and 5B (that correspond to FIG. 3C) and FIGS. 5C and 5D (that correspond to FIG. 3D) are, and such additional figures do not deviate from the spirit and the protection scope of the present disclosure. For example, such additional figures would depict the same aspects as shown in FIGS. 5A-5D and the respective relationships to FIGS. 3C and 3D as disclosed herein, but with respect to the other modes and topologies disclosed herein instead of the CV mode (principal diagonal topology) shown in FIGS. 5A-5D. For example, for CC mode (principal diagonal topology) (e.g., FIGS. 3A and 3B), such additional figures would depict an inverter configured to convert an input DC power of the wireless IPT system into an input AC power of the wireless IPT system. Here, the first control variable is an output DC current of the wireless IPT system, and the second control variable is (i) an output DC voltage of a second DC power, or (ii) an output voltage of the inverter, and the controller is configured to generate the second control variable by comparing the output DC current with a set output DC current of the wireless IPT system. In one aspect, there is a DC/DC converter configured to convert a first DC power at a first voltage to the second DC power at a second voltage. The inverter is electrically coupled with the DC/DC converter and configured to convert the second DC power to an input AC power of the wireless IPT system, and the controller is further configured to regulate the second DC power output from the DC/DC converter by adjusting a duty cycle in the DC/DC converter based on the second control variable. In another aspect, the controller is further configured to regulate the input AC power of the wireless IPT system by phase shifting in the inverter based on the second control variable. For CC mode (secondary diagonal topology) (e.g., FIGS. 4C and 4D, such additional figures would depict the first control variable is an output DC current of the wireless IPT system, and the second control variable is (i) a primary AC current of the transmitter, or (ii) an output DC current of a second DC power, and the controller is configured to generate the second control variable by comparing the output DC current with a set output DC current of the wireless IPT system. In one aspect, there is a DC/DC converter configured to convert a first DC power at a first voltage to a second DC power at a second voltage, and an inverter electrically coupled with the DC/DC converter and configured to convert the second DC power to an input AC power of the wireless IPT system. The controller is configured to regulate the second DC power output from the DC/DC converter by adjusting a duty cycle in the DC/DC converter based on the second control variable. In another aspect, the inverter is configured to convert an input DC power of the wireless IPT system into an input AC power of the wireless IPT system, and the controller is further configured to regulate the input AC power of the wireless IPT system by phase shifting in the inverter based on the second control variable. For CV mode (secondary diagonal topology) (e.g., FIGS. 4A and 4B), such additional figures would depict an inverter configured to convert an input DC power of the wireless IPT system into an input AC power of the wireless IPT system, the first control variable is an output DC voltage of the wireless IPT system, and the second control variable is (i) an output DC voltage of a second DC power, or (ii) an output voltage of the inverter. Here, the controller is configured to generate the second control variable by comparing the output DC voltage with a set output DC voltage of the wireless IPT system. In one aspect, there is a DC/DC converter configured to convert a first DC power at a first voltage to a second DC power at a second voltage, the inverter is electrically coupled with the DC/DC converter and configured to convert the second DC power to an input AC power of the wireless IPT system, and the controller is further configured to regulate the second DC power output from the DC/DC converter by adjusting a duty cycle in the DC/DC converter based on the second control variable. In another aspect, the controller is further configured to regulate the input AC power of the wireless IPT system by phase shifting in the inverter based on the second control variable. FIGS. 3A-3D, 4A-4D, and 5A-5D also depict various set voltages and set currents (e.g., derived set voltages, derived set currents, see the “set” quantities in these figures).

Example embodiments of wireless IPT systems and methods for operating the wireless IPT systems are described above in detail. The systems and methods are not limited to the specific embodiments described herein but, rather, components of the systems and/or operations of the methods may be utilized independently and separately from other components and/or operations described herein. Further, the described components and/or operations may also be defined in, or used in combination with, other systems, methods, and/or devices, and are not limited to practice with only the systems described herein.

As discussed above in connection with FIGS. 1C and 1D, Prior techniques only use adjusting Vᵢₙ or V_{AB} to realize CC (the principal diagonal is zero) or CV (the secondary diagonal is zero) mode. Therefore, extra switches to switch to different topologies to realize CC and CV mode are needed in conventional techniques. The techniques disclosed herein add new aspects of adjusting Iₚ or Iᵢₙ to the topology in which the secondary diagonal is zero. This enables realizing CC in this topology. The techniques described herein add new aspects of adjusting Iₚ or Iᵢₙ to the topology in which the principal diagonal is zero. This enables realizing CV in this topology. As such, the techniques disclosed herein represent significant advancements and corresponding benefits over these conventional techniques.

At least one technical effect of the systems and methods described herein includes (a) reducing the amount of and/or need for circuit components such as switches; (b) improving the process of switching back and forth between CC and CV modes; (c) improving the safety and efficient charging of batteries; (d) use of any single topology to achieve both CC and CV; (e) variable control using control voltages/currents, where the variable control can be implemented via software (allowing for smoother switching compared to prior techniques); (f) adjusting control variables (e.g., Iₚ or Iᵢₙ) to the topology in which the secondary diagonal is zero, which enables realizing CC in this topology, and adjusting control variables (e.g., Iₚ or Iᵢₙ) to the topology in which the principal diagonal is zero, which enables realizing CV in this topology; (g) both topologies in which the principal diagonal is zero or the secondary diagonal is zero can realize CC and CV; (h) utilizing loops (e.g., feedback loops) as part of control and/or setting scheme(s); (i) controlling aspects (e.g., duty cycle, phase shift) of components (e.g., DC/DC converter, inverter) to provide desired control, and (j) general improvements in circuitry design and computer control (e.g., software) in battery charging technology.

Example embodiments of wireless IPT systems and methods for operating the wireless IPT systems are described above in detail. The systems and methods are not limited to the specific embodiments described herein but, rather, components of the systems and/or operations of the methods may be utilized independently and separately from other components and/or operations described herein. Further, the described components and/or operations may also be defined in, or used in combination with, other systems, methods, and/or devices, and are not limited to practice with only the systems described herein.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates s otherwise. “Approximately” and/or “substantially” as applied to a particular value of a range applies to both values, and unless otherwise dependent on the precision of the instrument measuring the value, may indicate +/−10% of the stated value(s).

As used herein, an element or step recited in the singular and proceeded with the word “a” or “an” should be understood as not excluding plural elements or steps, unless such exclusion is explicitly recited. Furthermore, references to “example” or “one example” of the present disclosure are not intended to be interpreted as excluding the existence of additional examples that also incorporate the recited features. Further, to the extent that terms “includes,” “including,” “has,” “contains,” and variants thereof are used herein, such terms are intended to be inclusive in a manner similar to the term “comprises” as an open transition word without precluding any additional or other elements.

As user herein, technology specific symbols such as “TX”, “RX”, “L”, “C”, should be understood as having a meaning within the applicable technology field, subject to the context of their usage. For example, without limitation, “TX” means transmit or transmitter, “RX” means receive or receiver, “L” represents an inductor, “C” represents a capacitor, and so on and so forth as understood in the art. This is not to be confused with certain abbreviations in the disclosure such as “CC” (constant charge) and “CV” (constant voltage).

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A wireless inductive power transfer (IPT) system for wirelessly charging a battery-powered device associated with said wireless IPT system, said wireless IPT system comprising:
a transmitter side subsystem comprising a transmitter, the transmitter configured to transmit a primary alternating current (AC) power;
a receiver side subsystem comprising a receiver, the receiver inductively coupled with the transmitter and configured to receive the primary AC power and output a secondary AC power, wherein the secondary AC power is rectified into a direct current (DC) output power for transmission; and
a controller operatively coupled to the transmitter side subsystem and the receiver side subsystem and configured to:
control charging of a battery associated with said wireless IPT system by controlling a current and/or a voltage of the receiver side subsystem to serve as an input control variable for entering into and/or switching between a constant current (CC) mode of the charging and a constant voltage (CV) mode of the charging using the same topology of a circuit of the wireless IPT system.

2. The wireless IPT system of claim 1, wherein the controller is further configured to:
control the charging with a first control loop and a second control loop, wherein a first control variable of the first control loop is different from a second control variable of the second control loop.

3. The wireless IPT system of claim 1, wherein the controller is further configured to:
realize the CC mode and the CV mode in a principal diagonal topology.

4. The wireless IPT system of claim 1, wherein the controller is further configured to:
realize the CC mode and the CV mode in a secondary diagonal topology.

5. The wireless IPT system of claim 3 further comprising:
an inverter configured to convert an input DC power of the wireless IPT system into an input AC power of the wireless IPT system,
wherein the controller is further configured to:
regulate the input AC power of the wireless IPT system by:
phase shifting in the inverter based on a second control variable.

6. The wireless IPT system of claim 2, further comprising an inverter configured to convert an input DC power of the wireless IPT system into an input AC power of the wireless IPT system,
wherein in the CC mode, the first control variable is an output DC current of the wireless IPT system, and the second control variable is (i) an output DC voltage of a second DC power, or (ii) an output voltage of the inverter, and the controller is further configured to:
generate the second control variable by comparing the output DC current with a set output DC current of the wireless IPT system.

7. The wireless IPT system of claim 6 further comprising:
a DC/DC converter configured to convert a first DC power at a first voltage to the second DC power at a second voltage, wherein
the inverter is electrically coupled with the DC/DC converter and configured to convert the second DC power to an input AC power of the wireless IPT system,
wherein the controller is further configured to:
regulate the second DC power output from the DC/DC converter by:
adjusting a duty cycle in the DC/DC converter based on the second control variable.

8. The wireless IPT system of claim 6, wherein the controller is further configured to:
regulate the input AC power of the wireless IPT system by:
phase shifting in the inverter based on the second control variable.

9. The wireless IPT system of claim 2, wherein in the CV mode, the first control variable is an output DC voltage of the wireless IPT system, and the second control variable is (i) a primary AC current of the transmitter, or (ii) an output DC current of a second DC power, and the controller is further configured to:
generate the second control variable by comparing the output DC voltage with a set output DC voltage of the wireless IPT system.

10. The wireless IPT system of claim 9 further comprising:
an inverter; and
a DC/DC converter configured to convert a first DC power at a first voltage to the second DC power at a second voltage, wherein
the inverter is electrically coupled with the DC/DC converter and configured to convert the second DC power to an input AC power of the wireless IPT system, and
the controller is further configured to:
regulate the second DC power output from the DC/DC converter by:
adjusting a duty cycle in the DC/DC converter based on the second control variable.

11. The wireless IPT system of claim 9, further comprising an inverter, wherein
the inverter is configured to convert an input DC power of the wireless IPT system into an input AC power of the wireless IPT system, and
the controller is further configured to:
regulate the input AC power of the wireless IPT system by:
phase shifting in the inverter based on the second control variable.

12. The wireless IPT system of claim 2, wherein in the CC mode, the first control variable is an output DC current of the wireless IPT system, and the second control variable is (i) a primary AC current of the transmitter, or (ii) an output DC current of a second DC power, and the controller is further configured to:
generate the second control variable by comparing the output DC current with a set output DC current of the wireless IPT system.

13. The wireless IPT system of claim 12 further comprising:
a DC/DC converter configured to convert a first DC power at a first voltage to a second DC power at a second voltage; and
an inverter electrically coupled with the DC/DC converter and configured to convert the second DC power to an input AC power of the wireless IPT system,
wherein the controller is further configured to:
regulate the second DC power output from the DC/DC converter by:
adjusting a duty cycle in the DC/DC converter based on the second control variable.

14. The wireless IPT system of claim 12, wherein
the inverter is configured to convert an input DC power of the wireless IPT system into an input AC power of the wireless IPT system, and
the controller is further configured to:
regulate the input AC power of the wireless IPT system by:
phase shifting in the inverter based on the second control variable.

15. The wireless IPT system of claim 2, further comprising an inverter configured to convert an input DC power of the wireless IPT system into an input AC power of the wireless IPT system,
wherein in the CV mode, the first control variable is an output DC voltage of the wireless IPT system, and the second control variable is (i) an output DC voltage of a second DC power, or (ii) an output voltage of the inverter, and the controller is further configured to:
generate the second control variable by comparing the output DC voltage with a set output DC voltage of the wireless IPT system.

16. The wireless IPT system of claim 15 further comprising:
a DC/DC converter configured to convert a first DC power at a first voltage to the second DC power at a second voltage, wherein
the inverter is electrically coupled with the DC/DC converter and configured to convert the second DC power to the input AC power of the wireless IPT system, and
the controller is further configured to:
regulate the second DC power output from the DC/DC converter by:
adjusting a duty cycle in the DC/DC converter based on the second control variable.

17. The wireless IPT system of claim 15, wherein the controller is further configured to:
regulate the input AC power of the wireless IPT system by:
phase shifting in the inverter based on the second control variable.

18. The wireless IPT system of claim 1, wherein the controller is further configured to:
operate the wireless IPT system at zero voltage switching of switches in the wireless IPT system.

19. A method of operating a wireless inductive power transfer (IPT) system for wirelessly charging a battery-powered device associated with said wireless IPT system, said wireless IPT system comprising a transmitter side subsystem comprising a transmitter, a receiver side subsystem comprising a receiver, said receiver inductively coupled with said transmitter, and a controller operatively coupled to said transmitter side subsystem and said receiver side subsystem, said method comprising:
transmitting, via the transmitter, a primary alternating current (AC) power;
receiving, via the receiver, the primary AC power;
outputting, via the receiver, a secondary AC power, wherein the secondary AC power is rectified into a direct current (DC) output power for transmission; and
controlling, via the controller, charging of a battery associated with the wireless IPT system by controlling a current and/or a voltage of the receiver side subsystem to serve as an input control variable for entering into and/or switching between a constant current (CC) mode of the charging and a constant voltage (CV) mode of the charging using the same topology of a circuit of the wireless IPT system.

20. The method of claim 19, further comprising:
controlling, via the controller, the charging with a first control loop and a second control loop, wherein a first control variable of the first control loop is different from a second control variable of the second control loop.

21. The method of claim 19, further comprising: controlling, via the controller, realization of the CC mode and the CV mode in a principal diagonal topology.

22. The method of claim 19, further comprising: controlling, via the controller, realization of the CC mode and the CV mode in a secondary diagonal topology.

23. The method of claim 21, wherein the wireless IPT system further comprises an inverter configured to convert an input DC power of the wireless IPT system into an input AC power of the wireless IPT system, the method further comprising:
regulating, via the controller, the input AC power of the wireless IPT system by phase shifting in the inverter based on a second control variable.

24. The method of claim 20, wherein the wireless IPT system further comprises an inverter configured to convert an input DC power of the wireless IPT system into an input AC power of the wireless IPT system, and in the CC mode, the first control variable is an output DC current of the wireless IPT system, and the second control variable is (i) an output DC voltage of a second DC power, or (ii) an output voltage of the inverter, the method further comprising:
generating, via the controller, the second control variable by comparing the output DC current with a set output DC current of the wireless IPT system.

25. The method of claim 24, wherein the wireless IPT system further comprises: a DC/DC converter configured to convert a first DC power at a first voltage to the second DC power at a second voltage, and the inverter is electrically coupled with the DC/DC converter and configured to convert the second DC power to an input AC power of the wireless IPT system, the method further comprising:
regulating, via the controller, the second DC power output from the DC/DC converter by adjusting a duty cycle in the DC/DC converter based on the second control variable.

26. The method of claim 24, further comprising:
regulating, via the controller, the input AC power of the wireless IPT system by phase shifting in the inverter based on the second control variable.

27. The method of claim 20, wherein in the CV mode, the first control variable is an output DC voltage of the wireless IPT system, and the second control variable is (i) a primary AC current of the transmitter, or (ii) an output DC current of a second DC power, the method further comprising:
generating, via the controller, the second control variable by comparing the output DC voltage with a set output DC voltage of the wireless IPT system.

28. The method of claim 27, wherein the wireless IPT system further comprises: an inverter; and a DC/DC converter configured to convert a first DC power at a first voltage to a second DC power at a second voltage, and the inverter is electrically coupled with the DC/DC converter and configured to convert the second DC power to an input AC power of the wireless IPT system, the method further comprising:
regulating, via the controller, the second DC power output from the DC/DC converter by adjusting a duty cycle in the DC/DC converter based on the second control variable.

29. The method of claim 27, wherein the wireless IPT system further comprises: an inverter configured to convert an input DC power of the wireless IPT system into an input AC power of the wireless IPT system, the method further comprising:
regulating, via the controller, the input AC power of the wireless IPT system by phase shifting in the inverter based on the second control variable.

30. The method of claim 20, wherein in the CC mode, the first control variable is an output DC current of the wireless IPT system, and the second control variable is (i) a primary AC current of the transmitter, or (ii) an output DC current of a second DC power, the method further comprising:
generating, via the controller, the second control variable by comparing the output DC current with a set output DC current of the wireless IPT system.

31. The method of claim 30, wherein the wireless IPT system further comprises: a DC/DC converter configured to convert a first DC power at a first voltage to a second DC power at a second voltage; and an inverter electrically coupled with the DC/DC converter and configured to convert the second DC power to an input AC power of the wireless IPT system, the method further comprising:
regulating, via the controller, the second DC power output from the DC/DC converter by adjusting a duty cycle in the DC/DC converter based on the second control variable.

32. The method of claim 30, wherein the inverter is configured to convert an input DC power of the wireless IPT system into an input AC power of the wireless IPT system, the method further comprising:
regulating, via the controller, the input AC power of the wireless IPT system by phase shifting in the inverter based on the second control variable.

33. The method of claim 20, wherein the wireless IPT system further comprises an inverter configured to convert an input DC power of the wireless IPT system into an input AC power of the wireless IPT system, and in the CV mode, the first control variable is an output DC voltage of the wireless IPT system, and the second control variable is (i) an output DC voltage of a second DC power, or (ii) an output voltage of the inverter, the method further comprising:
generating, via the controller, the second control variable by comparing the output DC voltage with a set output DC voltage of the wireless IPT system.

34. The method of claim 33, wherein the wireless IPT system further comprises: a DC/DC converter configured to convert a first DC power at a first voltage to a second DC power at a second voltage, and the inverter is electrically coupled with the DC/DC converter and configured to convert the second DC power to the input AC power of the wireless IPT system, the method further comprising:
regulating, via the controller, the second DC power output from the DC/DC converter by adjusting a duty cycle in the DC/DC converter based on the second control variable.

35. The method of claim 33, further comprising:
regulating, via the controller, the input AC power of the wireless IPT system by phase shifting in the inverter based on the second control variable.

36. The method of claim 19, the method further comprising operating, via the controller, the wireless IPT system at zero voltage switching of switches in the wireless IPT system.

37. The wireless IPT system of claim 4 further comprising:
an inverter configured to convert an input DC power of the wireless IPT system into an input AC power of the wireless IPT system,
wherein the controller is further configured to:
regulate the input AC power of the wireless IPT system by:
phase shifting in the inverter based on a second control variable.

38. The method of claim 22, wherein the wireless IPT system further comprises an inverter configured to convert an input DC power of the wireless IPT system into an input AC power of the wireless IPT system, the method further comprising:
regulating, via the controller, the input AC power of the wireless IPT system by phase shifting in the inverter based on a second control variable.
